(19) United States
(12) Patent Application Publication
(10) Pub. No.: US 2013/0057392 A1
(43) Pub. Date: Mar. 7, 2013

(54) Method and System for Disabling an Electronic Device

(71) Applicant: Roddy M. Bullock, Milford, OH (US)

(72) Inventor: Roddy M. Bullock, Milford, OH (US)

(21) Appl. No.: 13/420,601

(22) Filed: Mar. 14, 2012

Related U.S. Application Data
(60) Provisional application No. 61/452,158, filed on Mar. 14, 2011.

(51) Int. Cl. G06K 7/01

(52) U.S. Cl. 340/10.5

(57) ABSTRACT

A portable electronic device. The portable electronic device is dependently operable on being remotely coupled to at least one RFID tag, the RFID tag being disposed on one of a piece of jewelry or a portion of clothing worn on a person. Upon removal of the jewelry or clothing the RFID tag is rendered inoperable and the electronic device is partially or completely disabled.

### CROSS REFERENCE TO RELATED APPLICATIONS

This application claims priority to U.S. Provisional Application 61/452,158, entitled System and Method for Disabling an Electronic Device, filed Mar. 14, 2011. This application also claims priority to U.S. Provisional Application 61/438,739, entitled System and Method for Disabling an Electronic Device, filed May 8, 2011.

### TECHNICAL FIELD

The invention relates to portable electronic devices, including cellular telephones, Smartphone, iPads, tablet computing devices, netbooks, laptop computers, and the like. The invention relates more particularly to methods and systems to mitigate the risk of information loss or unauthorized use due to device loss or theft.

### BACKGROUND OF THE INVENTION

Portable and handheld computing devices, including cellular telephones, Smartphone, iPads, tablet computing devices, netbooks, laptop computers, and the like are becoming more prevalent in modern society. These devices increasingly contain information about and access to an owner's personal life and personally identifiable information. For example, these devices can have stored in memory the user's credit card information. These devices are also increasingly performing more functions, such as replacing car keys for starting an automobile, or holding confidential business information.

Clearly, the loss of a modern handheld computing device can cause great injury to the owner. A lost or stolen device may permit the finder or thief to access the legitimate owner's personally identifiable information and other information such as banking or medical records. The unauthorized user can misappropriate personal property such as a car, misappropriate real property such as a house, and otherwise steal the legitimate user's identity.

Current safeguards, such as password protection are not sufficient. If, for example, a handheld computing device is stolen after the user enters the password, the device can be used by the thief.

There is a continuing unaddressed need for product, system, or method for ensuring a higher degree of device protection against loss or theft.

### SUMMARY OF THE INVENTION

A portable electronic device is disclosed. The portable electronic device is dependently operable on being remotely coupled to at least one RFID tag, the RFID tag being disposed on one of a piece of jewelry or a portion of clothing worn on a person. Upon removal of the jewelry or clothing the RFID tag is rendered inoperable and the electronic device is partially or completely disabled.

### BRIEF DESCRIPTION OF THE DRAWINGS

Preferred embodiments of the invention are described below with reference to the following accompanying drawings.

FIG. 1 is a block diagram of a system of the present invention, including a tag and reader in which the invention could be incorporated.

FIG. 2 is a flowchart illustrating steps performed in one embodiment of the present invention.

FIG. 3 is a block diagram of an embodiment of an RFID communication system, including a tag and reader, embodying various aspects of the invention.

FIG. 4 is a flowchart illustrating steps performed by the tag and reader of FIG. 3.

FIG. 5 is a block diagram of an illustrative RF addressable sensor network according to an embodiment of the present invention.

FIG. 6 is a block diagram of an illustrative RF addressable sensor according to embodiments of the present invention.

FIG. 6A is a block diagram of an illustrative RF addressable sensor according to embodiments of the present invention.

FIG. 7 is a block diagram of a wireless sensor reader according to embodiments of the present invention.

FIGS. 8A, 8B, and 8C are block diagrams of wireless sensor reader configurations according to embodiments of the present invention.

FIG. 9 is a flowchart illustrating an operational sequence of RF addressable sensor read communications from the perspective of the wireless sensor reader according to an embodiment of the present invention.

FIG. 11A is a flowchart illustrating a method of RF addressable sensor read communications from the perspective of a basic single RF addressable sensor reader according to an embodiment of the present invention.

FIG. 11B is flowchart illustrating a method of RF addressable sensor read communications from the perspective of an RF addressable sensor having local processing capabilities according to an embodiment of the present invention.

### DETAILED DESCRIPTION OF THE PREFERRED EMBODIMENTS

The following US patents and applications are incorporated herein by reference for their enabling teaching of methods, systems, and devices related to remote wireless communication: U.S. patent application Ser. No. 10/263,826 entitled “Radio Frequency Identification Device Communications Systems, Wireless Communication Devices, Wireless Communication Systems, Backscatter Communication Methods, A Radio Frequency Identification Device and A Radio Frequency Identification Device Communication Method” by inventors Mike A. Hughes and Richard M. Pratt; U.S. patent application Ser. No. 10/263, 809, entitled “Method of Simultaneously Reading Multiple Radio Frequency Tags, RF Tag, and RF Reader”, by inventors Emre Ertin, Richard M. Pratt, Mike A. Hughes, Kevin L. Priddy, and Wayne M. Lechelt; U.S. patent application Ser. No. 10/263, 873, entitled “RFID System and Method Including Tag ID Compression”, by inventors Mike A. Hughes and Richard M. Pratt; U.S. patent application Ser. No. 10/264,078, entitled “System and Method to Identify Multiple RFID Tags”, by inventors Mike A. Hughes and Richard M. Pratt; U.S. Patent application Ser. No. 10/263,940, entitled “Wireless Communication Devices, Radio Frequency Identification Devices, Backscatter Communication Device Wake-Up Methods, Communication Device Wake-Up Methods and A Radio Frequency Identification Device Wake-Up Method”, by inventors Richard Pratt and Mike Hughes; U.S. patent application Ser. No. 10/263,997, entitled “Wireless Communication Systems, Radio Frequency Identification Devices, Methods of Enhancing a Communications Range of a Radio Frequency Identification Device, and Wireless Communication Methods”, by inventors Richard Pratt and Steven B. Thompson; U.S. patent application Ser. No. 10/263,670, entitled “Wireless Communications Devices, Methods of Processing a Wireless Communication Signal, Wireless Communication Synchronization Methods and a Radio Frequency Identification Device Communication Method”, by inventors Richard M. Pratt and Steven B. Thompson; U.S. patent application Ser. No. 10/263,656, entitled “Wireless Communications Systems, Radio Frequency Identification Devices, Wireless Communications Methods, and Radio Frequency Identification Device Communications Methods”, by inventors Richard Pratt and Steven B. Thompson; U.S. patent application Ser. No. 09/589,001, filed Jun. 6, 2000, entitled “Remote Communication System and Method”, by inventors R. W. Gilbert, G. A. Anderson, K. D. Steele, and C. L. Carrender; U.S. patent application Ser. No. 09/802,408, filed Mar. 9, 2001, entitled “Multi-Level RF Identification System”, now U.S. Pat. No. 6,765,476; by inventors R. W. Gilbert, G. A. Anderson, and K. D. Steele; U.S. patent application Ser. No. 09/833,465, filed Apr. 11, 2001, entitled “System and Method for Controlling Remote Device”, by inventors C. L. Carrender, R. W. Gilbert, J. W. Scott, and D. Clark; U.S. patent application Ser. No. 09/588,997, filed Jun. 6, 2000, entitled “Phase Modulation in RF Tag”, by inventors R. W. Gilbert and C. L. Carrender; U.S. patent application Ser. No. 09/589,000, filed Jun. 6, 2000, entitled “Multi-Frequency Communication System and Method”, by inventors R. W. Gilbert and C. L. Carrender, now U.S. Pat. No. 6,745,008; U.S. patent application Ser. No. 09/588,998, filed Jun. 6, 2000, entitled “Distance/Ranging by Determination of RF Phase Delta”, by inventor C. L. Carrender; U.S. patent application Ser. No. 09/797,539, filed Feb. 28, 2001, entitled “Antenna Matching Circuit”, by inventor C. L. Carrender, now U.S. Pat. No. 6,738,025; U.S. patent application Ser. No. 09/833,391, filed Apr. 11, 2001, entitled “Frequency Hopping RFID Reader”, by inventor C. L. Carrender; U.S. patent application Ser. No. 12/287,565, filed Oct. 9, 2008, entitled “Electronic Device with Radio Frequency Identification (RFID) Technology, inventors Yu Zhao and Hui Yang.

The invention addresses the problem of loss by, or theft from, a rightful user of a portable electronic device. In general, as described in detail herein, the invention involves the portable electronic device being in dependent operable communication with a portable remote coupled device. In an embodiment the portable electronic device is selected from the group consisting of a telephone, a cellular telephone, a Smartphone, a tablet device, such as an iPad, and the like. In an embodiment, communication is via radio frequency and the remote coupled device is a Radio Frequency Identification (RFID) device, commonly called an RF tag, and at times referred to herein as an RF addressable sensor.

In an embodiment, the portable electronic device is a Smartphone, and wireless communication is via radio frequency and one or more remote coupled devices include one or more RFID devices.

As used herein the term Smartphone is used in its normal, accepted meaning, including device that is a cellular telephone with built-in applications and Internet access. Smartphones can provide digital voice service as well as text messaging, e-mail, Web browsing, still and video cameras, MP3 player, video viewing and often video calling. Currently Smartphones operate on known operating systems, such as Symbian, Android, Blackberry, Apple iOS, and Windows, each operating system of which can be adapted by known means by persons of ordinary skill as necessary for the invention described herein.

While not intending to be limited to current technology and current convention, in general, for RFID technology, the present invention follows the following convention with respect to common radio frequency bands: Low Frequency (LF), <135 kHz, including 120 to 150 kHz, or 125 to 134 kHz; High Frequency (HF), 13.56 MHz, including 13.533 to 13.567 MHz, (sometimes referred to as “Medium Frequency” and also is used for the ISM band worldwide); Ultra High Frequency (UHF), 433 MHz and 860 to 956 MHz; Microwave Frequency, 2.45 to 5.8 GHz. Further information with respect to frequency ranges and allowed fieldstrength/transmission power can be obtained at the disclosure of http://rfid-handbook.com/, which is hereby incorporated by reference herein.

By “dependent operable communication” is meant that the operation of the portable electronic device is at least partially dependent upon being in communication with the remote device to which it is coupled, such as by radio frequency communication. Once the coupling is broken, the portable electronic device is no longer in communication with the coupled device, and is, therefore, no longer operable or at least partially disabled.

By “remote” is meant wirelessly separated. For example, a wireless computer mouse and a computer having a sensor to sense the wireless mouse, are each remote from the other and coupled for operable communication.

In one embodiment, the portable electronic device can be in complete dependent operable communication, in which case upon breaking of the coupling with the remote device, the portable electronic device is immediately and completely disabled such that it can perform no functions. A completely disabled electronic device is one which is in a state equivalent to “off”.

In one embodiment, the portable electronic device can be in limited dependent operable communication, in which case upon breaking of the coupling with the remote device, the portable electronic device is disabled to a limited extent, such that it can perform some functions but not others. A partially disabled electronic device is one which is in a state equivalent to “on” but for which some functionality is blocked. For example, in an embodiment, the portable electronic device can be in limited dependent operable communication, such that upon breaking of the coupling with the remote device, the portable electronic device is disabled except to receive a passcode, password, or the like. That is, a correctly entered password can override the disabling due to being out of range of the remote coupled device.

In an embodiment, the portable electronic device can be in limited dependent operable communication, such that upon breaking of the coupling with the remote device, the portable electronic device is disabled except to operate with predetermined approved functions, such as a telephone; that is, the device can access no data from memory and no access can be made to stored data such as email data. In this mode, the device can be used as a telephone, but no sensitive data stored on the device can be accessed, and no functions such as electronic wallet functions can be utilized.

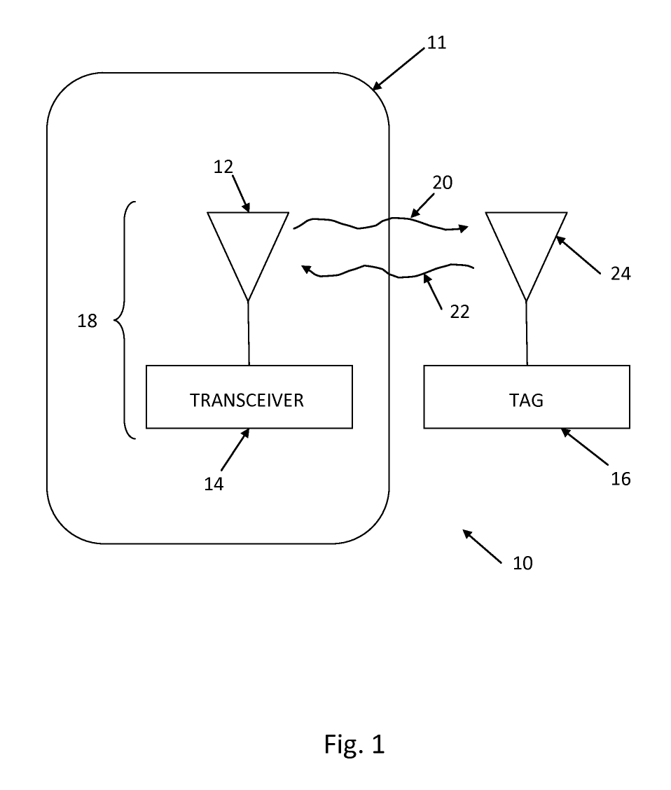

As shown in FIG. 1, a basic system 10 of the present invention includes a portable electronic device 11 having as a part thereof an interrogator 18. The system 10 also includes at least one transponder, or RF addressable sensor, which can be an RF tag 16. The interrogator 18 includes a transceiver which can include a decoder 14 and an antenna 12. The tag 16 includes an antenna 24. In operation, the antenna 12 emits and receives electromagnetic radio signals generated by the transceiver 14 to activate the tag 16 and receive signals from the tag. When the tag 16 is activated, data can be read from or written to the tag. The RF tag data can be configured or programmed so that the interrogator 18 can recognize an RF tag intended to be recognized, and, therefore, considered “coupled” to the interrogator.

The interrogator 18 can emit radio signals 20 in a range from one inch to one hundred feet or more, depending upon its power output and the radio frequency used. When a coupled RF tag 16 is within range of the electromagnetic radio waves 20, the tag detects the signal 20 and is activated. Data encoded in the coupled RF tag 16 can then be transmitted by a modulated data signal 22 through an antenna 24 to the interrogator 18 for subsequent processing.

When interrogator 18 receives data signal 22, portable electronic device 11 can operate normally for all functions. However, if portable electronic device 11 and coupled RF tag 16 become separated by a distance beyond which either radio waves 22 or data signal 22 can be detected, then portable electronic device 11 can become either completely or partially disabled.

In one mode of operations, therefore, a user of a portable electronic device of the invention can have on his or her body, in his or her wallet or purse, in his or her clothing, or in his or her automobile a coupled RF tag 16. As long as the user is in possession of the portable electronic device 11, and is, therefore in range of the coupled RF tag 16, the portable electronic device 11 works normally. But if the portable electronic device is lost, stolen, or otherwise not in close proximity to the user, the device, being out of range of the coupled RF tag, becomes either completely or partially disabled.

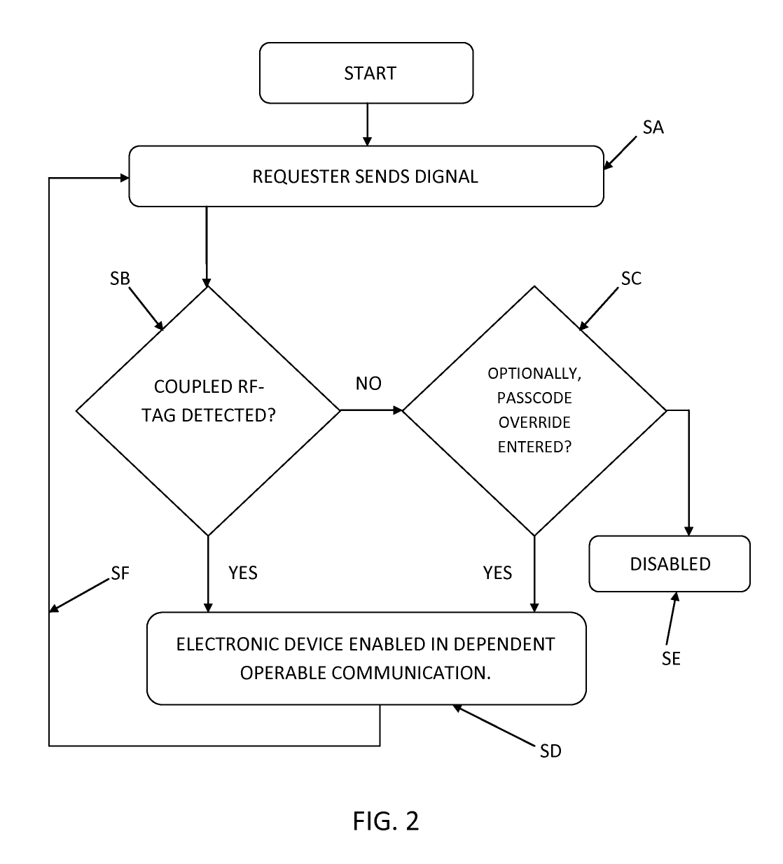

An embodiment of a method of the present invention utilizing an RF tag as a remote coupled device is described with respect to the flowchart of FIG. 2. At Step A, SA, the requestor, which can be a component of the portable electronic device 11 e.g., a built-in interrogator, emits a signal. At Step B, SB, the interrogator's transceiver either receives a signal from a remote coupled RF tag or it doesn't. Again, by “coupled RF tag” is meant an RF tag intended to be a part of the system, such that upon detection, which can be by receipt of a predetermined coded signal, the portable electronic device becomes or remains operable.

If at SB the interrogator does not receive a signal from the coupled RF tag, or at least one of multiple coupled RF tags, the system can execute at Step C, SC, an optional step of querying for a password or passcode. The purpose of the optional passcode is in anticipation of events in which the rightful user of the portable electronic device may not be in operable proximity to the coupled RF tag, or may lend the portable electronic device to another who does not have the coupled RF tag, or other events in which the rightful owner desires to use the portable electronic device in the absence of the coupled RF tag.

If at optional SC a proper passcode is entered, or, if at SB a remote coupled RF tag was detected, then at Step D, SD, executable instructions in the device memory of the portable electronic device can be utilized to enable the portable electronic device to operate fully for its intended purpose. Instructions from device memory or executable instructions can be identical or similar to such instructions and memory utilized on current devices that are enabled upon entering a passcode.

However, if the coupled RF tag is not detected and, optionally, if a passcode is not entered, at Step E, SE, executable instructions in the device memory of the portable electronic device either partially or fully disable the portable electronic device, rendering it either partially or fully inoperable.

In one embodiment, partial disablement of a portable electronic device includes disabling all internet access, all document storage, all bank account information and banking capability, or all memory containing personally identifiable information, but enabling or continuing to enable telephone service. In this embodiment, a rightful user can still use the telephone function, which, in other embodiments of the invention can be utilized to enable further functionality.

In an embodiment disablement is complete; that is, the device is completely “off” with no powered operations. In an embodiment disablement is powered partial, in that the device can be “on” but no functions can be utilized until a remote coupled device is detected and/or a passcode is entered. In an embodiment disablement is function-specific partial, in that the device can be “on” but certain predetermined functions, such as the telephone function, can be utilized until a remote coupled device is detected and/or a passcode is entered, at which time full functionality can be restored.

Referring back to FIG. 2, once the remote coupled device is detected and the portable electronic device is operable, the cycle can be repeated as Step F, SF, at predetermined intervals. The predetermined intervals can be from a range of once every millisecond to once every half hour, the range including every millisecond interval in between. Thus, one minute, two minutes, ten minutes, and every other multiple of milliseconds between one and half an hour, are literally disclosed herein.

The method described in FIG. 2 can run as a loop constantly, providing for constant, uninterrupted operation of a portable electronic device unless and until a remote coupled device is not detected, at which time operation is partially or fully disabled, as predetermined by the user. As such, in an embodiment, the invention can be described as a portable electronic device in dependent operable communication with a remote coupled device. That is, operation of the electronic device is dependent upon its being in range of a remote coupled device, e.g., an RF tag.

In an embodiment the remote coupled device can be an RF tag associated with the rightful user's credentials for workplace security. For example, if the user has an access badge or other object containing an RF tag, the RF tag can be used not only for the user's other security-related activities, such as building entry, but can also serve as the remote coupled device for the user's portable electronic device. In this manner, an employee with a company-issued portable electronic device need not carry on his or her person RF tags; the RF tag for company security can be designed or programmed to also be the remote coupled device for portable electronic device security.

In an embodiment, the electronic device is not portable. For example, the methods, systems, and apparatus of the present invention can be applied with beneficial results to the use of a desktop computer, for example. In the context of a desktop the threat may not be loss or theft of the device, but the benefit can be convenience and protection against unauthorized use. If the desktop computing device detects the remote coupled device, the user at the desktop need not enter any passwords for use of the desktop computer.

Although other remote coupled devices, such as powered radio transceivers, are contemplated for use as the remote coupled device, an advantage of RFID systems and RF tags is the small size of the non-contact, non-line-of-sight capability of the technology. RF tags can be thin enough to keep on a card in one's wallet or attached to clothing, and small enough to be embedded in dentures are swallowed in a capsule, but they can be read through a variety of substances such as snow, fog, ice, paint, dirt, clothing and other visually and environmentally challenging conditions where other remote devices, such as bar codes or other optically-read technologies, would be useless. RF tags can also be read at remarkable speeds, in some cases responding in less than one hundred milliseconds.

There are three main categories of RFID tag systems that can be used as the remote coupled devices of the invention. These are systems that employ beam-powered passive tags, battery-powered semi-passive tags, and active tags. Each operates in fundamentally different ways. The invention described herein can be embodied in any of these types of systems.

The beam-powered RFID tag is often referred to as a passive device because it derives the energy needed for its operation from the radio frequency energy beamed at it. The tag rectifies the field and changes the reflective characteristics of the tag itself, creating a change in reflectivity that is seen at the interrogator. A battery-powered semi-passive RFID tag operates in a similar fashion, modulating its RF cross-section in order to change its reflectivity that is seen at the interrogator to develop a communication link. Here, the battery is the only source of the tag's operational power. Finally, in the active RFID tag, both the tag and reader have transceivers to communicate and are powered by a battery.

The range of communication for RF tags varies according to the transmission power of the interrogator 18 and the RF tag 16. Battery-powered tags operating at 2,450 MHz can be limited to less than ten meters in range. However, devices with sufficient power can reach in excess of 100 meters in range, depending on the frequency and environmental characteristics. RF tags of the present invention can be chosen as desired; for general use a range of ten meters can be sufficient, as most people never intentionally go more than ten meters from their portable electronic devices, especially when the devices contain valuable information or functionality, such as the ability to start one's car or make point-of-sale credit card purchase. However, for some uses, an RF tag in one's car, for example, with a range of 100 meters, may suffice for every day uninterrupted operation.

RF tag systems can utilize continuous wave backscatter to communicate data from the RF tag 16 to the interrogator 18. More specifically, the interrogator 18 can transmit a continuous-wave radio signal to the tag 16, which modulates the signal 20 using modulated backscattering wherein the electrical characteristics of the antenna 24 are altered by a modulating signal from the tag that reflects a modulated signal 22 back to the interrogator 18. The modulated signal 22 can be encoded with information from the tag 16. The interrogator 18 can then demodulate the modulated signal 22 and decodes the information. In the present invention, the decoded information can identify a coupled remote RF tag, thereby permitting operation of the portable electronic device.

Conventional continuous wave backscatter RF tag systems utilizing passive (no battery) RF tags require adequate power from the signal 20 to power the internal circuitry in the tag 16 used to modulate the signal back to the interrogator 18. While this is successful for tags that are located in close proximity to an interrogator, for example less than three meters, this may be insufficient range for some applications, for example greater than 100 meters. In the present invention, it is contemplated that most users will likely have the remote coupled RF tag on their person, such as in a pocket, a purse, a wallet, or hidden in clothing, so that passive RF tags can be utilized for the present invention.

The system of the invention can utilize more than one RF tag 16 for each portable electronic device 11. For example, a user can have a coupled RF tag in his or her car and on his or her person. Likewise, the user may have a coupled RF tag in one or more of his or her clothing, his or her house or office, his or her purse or brief case, office, and the like. When more than one RF tag 16 is utilized, the system can operate in a mode that requires one or more of the RF tags to be in range. Likewise, a building may contain multiple RF tags placed throughout so that occupants of the building can utilize the system without having to concern themselves with having RF tags on their person.

When more than one RF tag 16 is utilized, the system can operate in a mode in which the portable electronic device 11 is disabled, either completely or partially, only when all of the RF tags are out of range.

Therefore, in an embodiment, the invention can be described as a portable electronic device in dependent operable communication with at least one of a plurality of remote coupled devices.

When more than one RF tag 16 is utilized, the system can operate in a mode in which the portable electronic device 11 is disabled, either completely or partially, if any one of the RF tags is out of range.

Therefore, in an embodiment, the invention can be described as a portable electronic device in dependent operable communication with all of a plurality of remote coupled devices. Coupling can be by radio frequency signal transmission.

In an embodiment, more than one portable electronic device can be coupled to one or more remote coupled devices. In this manner, a rightful user of two portable electronic devices, such as a telephone and a tablet computer, can have both portable electronic devices coupled to a single RF tag.

Therefore, in an embodiment, the invention can be described as at least one portable electronic device, each portable electronic device in dependent operable communication with at least one remote coupled device.

Having more than one RF tag 16 remotely coupled to a portable electronic device 11 has many advantages. For example, if the system is set up to permit operation of portable electronic device 11 when in range of at least one, but not all, RF tags 16, then the user need not worry if he or she has an RF tag on her person at all times; she need only have an RF tag in her car, her home, office, and the like. If the system is set up to permit operation of the portable electronic device 11 only if all RF tags 16 are in range, then if a thief steals the user's portable electronic device 11 and a coupled RF tag 16 from the user's person, then the portable electronic device can still be disabled when the portable electronic device 11 goes out of range of any one of another of the remotely coupled RF tags 16, such as a coupled RF tag 16 in the user's car.

In an embodiment, the operation of multiple RF tags can be set remotely, such as by telephone or internet web address, by a rightful owner of a portable electronic device. In this manner, the rightful owner can set or change the parameters of use, including the operation of RF tags. For example, if the system is set to operate in a mode in which the portable electronic device 11 is enabled, either completely or partially, if any one of the RF tags 16 is in range, and the device is stolen, the rightful owner, via telephone or internet web access, can change the operation so that the device is disabled if it is out of range of any one of the RF tags. Likewise, the rightful owner can simply change the mode of operation to completely disable the device, regardless of the proximity of any remotely coupled devices. Telephone or web access intervention can be contingent upon the rightful owner producing an access code, passcode, password, or the like.

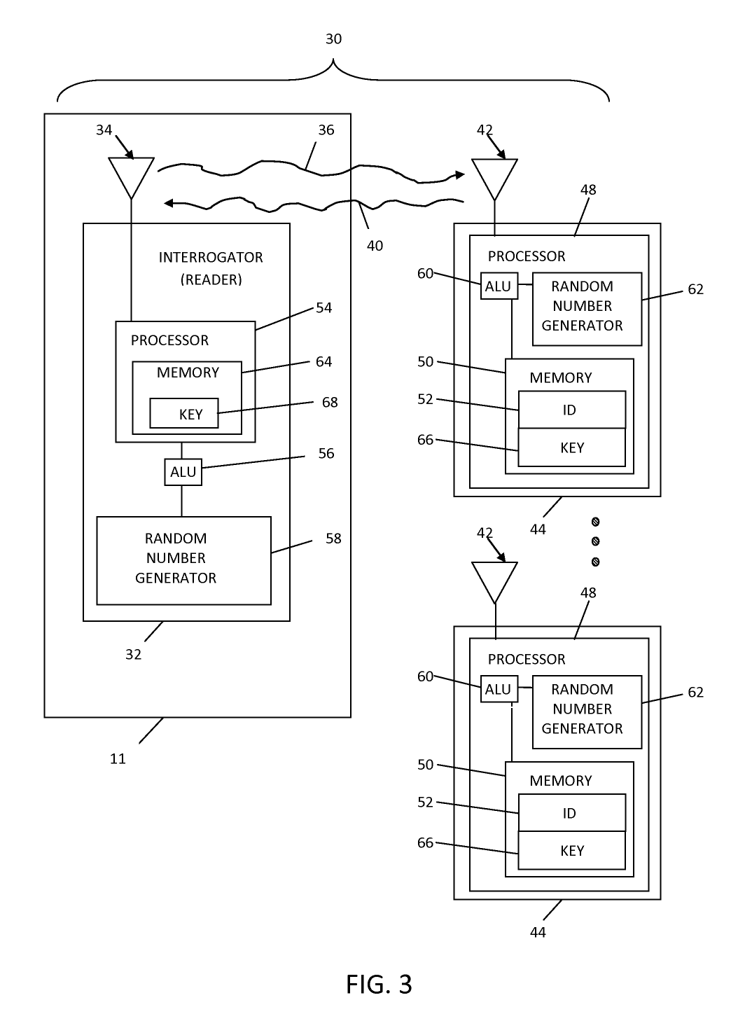

The method, systems, and apparatus of the invention can utilize procedures to authenticate and secure communications between the portable electronic device and any coupled RF tag(s). One method of authentication is described with respect to FIG. 3.

As shown in FIG. 3, an embodiment of the present invention having enhanced authentication utilizes an RF communication system 30 between a portable electronic device 11 and a remote coupled device, e.g., a processor-containing RF tag 44 that employs backscatter signals. The RF communication system 30 includes a portable electronic device 11 containing a reader or interrogator 32 that includes an antenna 34 through which the reader can transmit an interrogation signal 36 to an RF tag 44. The RF tag 44 modulates the continuous wave interrogation signal 36 to produce a backscatter response signal 40 that is transmitted back to the interrogator 32. The response signal 40 can include an identification code stored in memory 50, or other data. While FIG. 3 shows only two tags 44, there could be one or multiple tags 44 in use, capable of communicating with the reader 32.

In the embodiment shown in FIG. 3, the RF tag 44 includes an antenna 42 coupled to a modulator defined by processor 48. The tag 44 includes a switch coupled between the antenna 42 and processor 48. In the embodiment of FIG. 3, the switch is included in the processor 48. Alternatively, the switch can be a switch external to the processor 48, such as an n-channel MOS transistor, a p-channel MOS transistor, a bi-polar transistor, or any of numerous other types of switches.

In FIG. 3, a modulating signal from the processor 48 is input to the antenna 42 to cause the antenna to alternately reflect or not reflect. One item that can be transmitted from the tag to the reader is an identification code that is stored in memory 50 of the RF tag 44. In one embodiment, after receiving a command, the reader sends a carrier wave or interrogation signal 36 that is received by the antenna 42, and that signal is selectively reflected or not reflected back by the antenna 42 by the tag 44 shorting or not shorting dipole halves of the antenna 42 to produce portions of the response signal 40 (backscatter communications). Other communication methods are possible.

It will be appreciated that the depiction of the RF tag 44 in FIG. 3 is one embodiment only; RFID tags are well-known in the art. For example, U.S. Pat. No. 4,075,632 to Baldwin et al., which is incorporated herein by reference, discusses in detail circuit structures that could be used to produce the RF tag 44, if modified as described below.

Similarly, the internal structures of the interrogator 32 are not shown in FIG. 3.

For example, the interrogator 32 can be the receiver described in U.S. Pat. No. 4,360,810 to Landt, which is incorporated herein by reference, modified as described below.

In the illustrated embodiment, the reader 32 includes a processor 54, which in turn includes an arithmetic logic unit (ALU) 56 and a random number generator 58. The processor 54 further includes a memory 64; alternatively, the reader 32 includes a memory separate from the processor 54. The memory 64 can store a secret key value 68, the use of which will be described in greater detail below. The memory 50 of each tag 44 can also store a secret key value 66 which, in the illustrated embodiment, is the same value as the key value 68.

The processor 54 includes other features typically included in processors of the type typically employed in RFID readers. In one embodiment, the random number generator 58 actually generates pseudo random numbers; i.e., the numbers generated may follow a pattern that could be recreated. While the random number generator 58 is shown as being separate from the ALU 56, in one embodiment, the random number generator 58 is defined in part by the ALU 56. Similarly, each of the RF tags 44 is shown as including an arithmetic logic unit (ALU) 60 and a random number generator 62. Depending on whether the tags 44 or the reader 32 will be the authenticator (as will be described below), the random number generator may be omitted from either the RF tags 44 or from the reader 32.

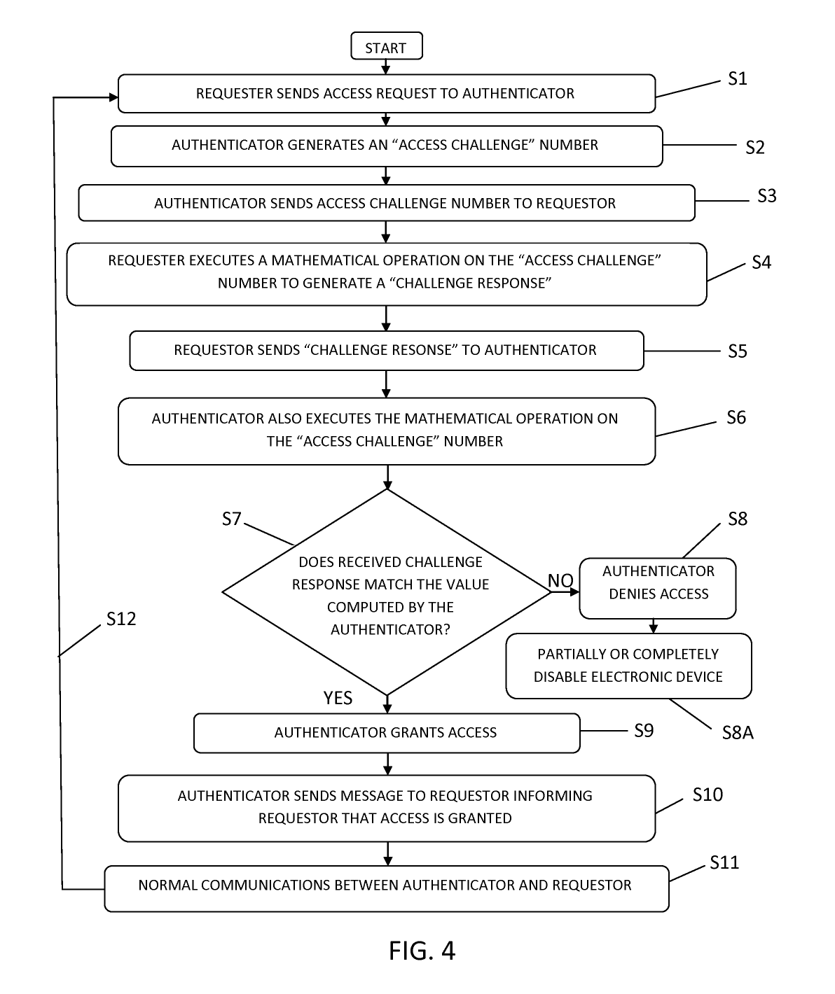

FIG. 4 is a flowchart illustrating steps performed in an embodiment by the tag and reader of FIG. 3, which tag and reader can be in coupled devices according to the present invention. Aspects of the invention that will be described in connection with FIG. 4 can be embodied in methods and apparatus employing tags of varying levels of sophistication. Multiple IF frequencies or read-while-write capability are not required. An advantage is that the amount of communication between the reader and the tags is minimized. This is useful to increase the speed of discovering or verifying the identities of tags.

Aspects of the invention described in connection with FIG. 4 also provide authentication (identity verification) over a public, open channel. This method can be used by the tag to authenticate the reader, or by the reader to authenticate the tag.

All participants in the authentication perform long, logical mathematical operations. More particularly, in step S1, the Requestor device requesting access (can be either a tag or the reader) sends a message to the Authenticator. In one embodiment, the Requestor is a tag 44 and the Authenticator is the reader 32. In another embodiment, the Requestor is the reader 32 and the Authenticator is a tag 44. In the embodiment of the claimed invention, it is contemplated that the Requestor is the reader and is a component of a portable electronic device, and the tag is an RF tag that is a remote coupled device.

In step S2, the Authenticator generates an “Access Challenge” number. In one embodiment, the “Access Challenge” number is a pseudo random number generated by the random number generator 58 or 62. In one embodiment, the “Access Challenge” value is a long binary value, which is randomly generated. The length can be 128 bits, 256 bits, 512 bits, or any desired value selected depending on the desired security level versus cost and processing time.

In step S3, the Authenticator sends the “Access Challenge” number or value to the Requestor.

In step S4, the Requestor performs a long mathematical operation (or series of mathematical operations) on the “Access Challenge” number based upon the secret key value 66 or 68 (see FIG. 2) to define a “Challenge Response.”

In step S5, the Requestor replies to the Authenticator with a “Challenge Response”.

In step S6, the Authenticator independently computes its own “Challenge Response” by performing the same mathematical operation of step S4 that the Requestor performed and by using the same key value that the Requestor performed. Step S6 could be performed after step S1 and before step S2, simultaneously with step S2, or at any time between step S1 and step S7.

In step S7, the Authenticator compares the received “Challenge Response” from the Requestor matches the value computed by the Authenticator. If not, the Authenticator denies access in step S8. If so, the Authenticator grants access in step S9. If the Authenticator denies access, this can be an indication that an RF tag is detected and responding, but the responding RF tag is not a coupled RF tag for the remote electronic device. In this case, further RF tags in range are likewise challenged, and if no RF tags transmit the correct challenge response, the portable electronic device is completely or partially disabled at S8A.

In step S10, the Authenticator can send a message to the Requestor informing the Requestor that access is granted. After step S10, normal communications are enabled in step S11, including transmission of additional information, if any, stored in the Authenticator to the Requestor (e.g., identification information, account information, financial information, etc.), and enablement of operation of the portable electronic device 11. Instructions in memory and executable instructions in the computing device can enable all predetermined functions according to known means in the art, that is, at this point, it is as if an electronic device was turned on and any necessary authenticating passwords were properly entered, and the device can be utilized for all enabled functions.

Upon authentication of the remotely coupled RF tag and enablement of operations of portable electronic device 11, the process of detecting a remotely coupled RF tag can repeat itself at predetermined intervals, S12. The predetermined intervals can be from a range of once every millisecond to once every half hour, the range including every millisecond interval in between.

Thus, one minute, two minutes, ten minutes, and every other multiple of milliseconds between one and half an hour, are literally disclosed herein.

The advantages of approach illustrated above include:

(1) The “Access Challenge” number is a generally random number, thereby helping to ensure security of the portable electronic device.
(2) The response to the Access Challenge is dependent upon the Challenge value, but is convoluted to obscure the key value.
(3) Multiple key values are possible, which can uniquely identify the RF tag.
(4) The length of the keys and challenge values can be configured to the security requirement at hand. Tradeoffs can be made between level of security and system cost. Greater security requires longer keys, longer messages, and more processor power.
(5) The approach of FIG. 4 can be used to generate encryption values for a data stream, in an alternative embodiment. The challenge response is not transmitted, but is used to encrypt the data stream.

The above approach can be implemented in a passive or semi-passive RFID application to provide a level of security and/or data encryption not presently available. The passive or semi-passive RFID application will require that the Authenticator initiate all communication processes with the Requestors. Various embodiments of the invention could be employed in security and inventory management applications.

In another embodiment, public key encryption can be used. Reader authentication occurs as follows. The reader requests to read or write tag data. The tag responds with a challenge value (random number). The reader encrypts the challenge value using its private key. The reader sends the encrypted challenge response to the tag. The tag uses the reader public key to decrypt the challenge response. The tag compares the results to the original challenge value and, if there is a match, the reader is authenticated.

The process for a tag authentication is as follows. The reader issues a request to a tag including a non-encrypted challenge value. The tag encrypts the challenge value using its private key, creating a challenge response. The tag sends the challenge response to the reader (no key is sent). The reader decrypts the challenge response using the known tag's public key. If the reader-computed result matches the original challenge value, the tag is authenticated.

In another embodiment related to those just described, both a tag and a reader function to authenticate the other. For example, a reader sends a non-encrypted first challenge value to a tag. The tag encrypts the first challenge value using a tag private key and sends it to the reader, as a first response, along with a non-encrypted second challenge value. The reader decrypts the first response using a tag public key, and compares the result with the non-encrypted first challenge value. If the comparison is valid, then the tag is determined to be authentic. The reader then encrypts the second challenge value using a reader private key and sends it to the tag as a second response. The tag then decrypts the second response using a reader public key, and compares the result with the non-encrypted second challenge value. If the comparison in valid, then the reader is also determined to be authentic. The tag and the reader may now continue with the exchange of data or commands.

In the embodiments just described above, it is assumed that both the reader and the RF tag(s) know the public key or keys of the other, in advance of the authentication process. This is a valid assumption if both (all) belong to the same system, in the control of the same user. In addition, multiple keys (public and private) may be used to realize corresponding level of security. Generally, the longer (i.e., more complex) the key length, the greater the level of security within the exchange. In the example just described, the non-encrypted first and second challenge values may be the same; responses would be different due to different private keys. Other embodiments using public and private keys are also possible.

Any design of RF tag can be used for security purposes. The addition of authentication capability described above provides an additional mechanism against spoofing. The security needs are many, with potential theft being high on the list. The traditional means of detecting when a theft has occurred is to track inventory. Items can be identified as they are removed from a monitored area or when subsequent inventories are made of the storage location.

Thus, methods and apparatus for authenticating reader or tags over a public, open channel have been provided. A system has been provided that is more robust against spoofing and other illicit access attempts than password-based methods.

However, other methods for authenticating readers can be utilized. For example, the system described in U.S. Pat. No. 7,806,325, issued Oct. 5, 2010 to O'Brien et al., and hereby incorporated by reference herein, can be utilized. In the O'Brien system, a signature is obtained from a contactlessly readable tag, such as the remote coupled RF tag of the present invention. The signature is decrypted to obtain a candidate identifier and a scrambling code associated with the signature. A remotely coupled RF tag can be identified by validating the candidate identifier based on at least one of the scrambling code and the signature. Once identified, the remote electronic device can be completely or partially enabled for use.

In another method for authentication, the present invention can utilize the system described in U.S. Pat. No. 7,450,010, issued Nov. 11, 2008 to Gravelle et al., and hereby incorporated by reference herein. The Gravelle method is a protocol for preserving the privacy of communications between an RFID reader (such as in a portable electronic device) and an RFID tag (such as the remotely coupled RF tag of the present invention). Two distinct actions are taken. First, the reader and the tag must be mutually authenticated as being authorized participants in the communications. This mutual authentication can be achieved as described in Gravelle by a user of a portable electronic device and at least one coupled RF tag. For example, the portable electronic device can “find” and “program” an RF tag under the rightful user's control, much as Bluetooth devices are activated today. After that process is successfully completed, the authenticity of each authorized participant must be validated prior to each subsequent communication between reader and tag.

In an embodiment, the present invention can utilize the system for utilizing parametric reradiated technology, as disclosed in U.S. Pat. No. 7,498,940, issued Mar. 3, 2009 to Pettus, and hereby incorporated by reference herein. The Pettus system can encode and decode information by use of radio frequency antennas. The system includes one or more interrogator devices and RFID data tags. The RFID data tags include a plurality of antenna elements which are formed on a substrate or directly on an object. The antenna elements are oriented and have dimensions to provide polarization and phase information, whereby this information represents the encoded information on the RFID tag. The interrogator device scans an area and uses radar imaging technology to create an image of a scanned area. The device receives re-radiated RF signals from the antenna elements on the data tags, whereby the data tags are preferably represented on the image. The re-radiated RF signals preferably include polarization and phase information of each antenna element, whereby the information is utilized using radar signal imaging algorithms to decode the information on the RF data tag. Such technology can find use in electronic devices that support radar technology.

In an embodiment, the present invention can utilize the cryptographic techniques taught in U.S. Pat. No. 7,532,104, issued May 12, 2009 to Juels. Such cryptographic techniques permit implementation in inexpensive radio frequency identification (RFID) tags or other RFID devices. In an RFID system comprising one or more RFID devices (such as remote coupled RF tags) and at least on reader (such as a reader component of a portable electronic device) that communicates with the devices, a plurality of pseudonyms is associated with a given one of the RFID devices. The pseudonyms can be predetermined or set by the user of the portable electronic device and RF coupled device. The RFID device transmits different ones of the pseudonyms in response to different reader queries, and an authorized verifier is able to determine that the different transmitted pseudonyms are associated with the RFID device.

RF tags of the present invention can be made in any way known in the art, and can be made according to the method disclosed in U.S. Pat. No. 7,636,044, issued Dec. 22, 2009 to Callaghan. RFID tags can be made in conjunction with an industrial controller to facilitate RFID tag printing and application of the RFID tags to manufactured items.

Systems of the present invention including an electronic device such as a smart phone and a coupled RFID tag can be made utilizing the technology enabled and disclosed in U.S. Pat. No. 7,148,803, issued Dec. 12, 2006 to Bandy et al. and its divisional and continuation patents and applications, each of which are incorporated by reference herein. In particular, the present invention can be made according to the teachings of the '803 patent as embodied in the technology currently available in the GT-601 NFC RFID Sensor Cell Phone manufactured by GENTAG, Inc., Washington D.C., USA, and RFID sensors also available from GENTAG, as disclosed at www.gentag.com.

Therefore, the present invention can be made by adapting the GENTAG, Inc. technology as enabled by GENTAG's patents and patent applications as well as by adapting GENTAG's off the shelf technology including RFID sensors, RFID diagnostic technology, including GENTAG's skin-patch technology. Adaptation by one skilled in the art can include adapting the device architecture, software, firmware, memory, or other components as necessary. For example, the skilled person can modify the wireless sensor reader disclosed at paragraph [0076] of US 2009/0212918 A1, which is a continuation application of the above-mentioned '803 patent, and, as mentioned above, is incorporated by reference herein. As disclosed in '918 the wireless sensor (which can be a portable electronic device as disclosed in this specification) reader can include an alarm for indicating when certain thresholds are reached or certain conditions are detected by an RF addressable sensor. In the present invention, rather than sound an alarm, the wireless sensor reader can have executable instructions in memory that cause the wireless sensor reader to be partially or completely disabled when the condition detected is, for example, the absence of a received signal from the RF addressable sensor.

In another embodiment, the invention can include additional loss and theft protection against unauthorized use of both the portable electronic device and the remote coupled device. It is foreseeable that a thief, for example, would in addition to stealing the portable electronic device also steal the authorized user's remote coupled device, which can be an RF addressable sensor, such as an RFID tag.

In an embodiment, the RF addressable sensor can be worn in close proximity to the authorized user's body in a manner that causes the portable electronic device to be disabled if the RF addressable sensor is removed from such proximity. In one embodiment, for example, the RF addressable sensor, such as an RFID tag can be embedded in, joined to, attached to, or otherwise disposed on a belt, bracelet, necklace, or other piece of clothing/jewelry such that removal of the clothing or jewelry destroys the RF addressable sensor, or otherwise renders the RF addressable sensor inactive. For example, a bracelet on which a coupled RFID tag is disposed can have an electrically conductive strip that completes a circuit when the bracelet is properly worn, and which, upon removal forces a break in the circuit, which in renders the RF addressable sensor inoperative or results in disablement of the portable electronic device or both. In this manner, if a thief were to steal a Smartphone and RFID tag coupled according to the present invention, the Smartphone could be disabled upon forced removal of the user's RFID bracelet. Of course, the same principle can be varied with different pieces of clothing or jewelry and with different technology, in ways known in the art. In an embodiment, for example, the RF addressable sensor can be adhered to a piece of clothing or jewelry such that upon removal the RF addressable sensor itself is destroyed, such as by tearing.

In another example, a bracelet, such as a paper or plastic strip having adhesive on one or both ends can be formed such that an RFID tag is disposed on or near a point of attachment, e.g. on or near the adhesive. The bracelet can be positioned around a wrist, ankle, forearm, or other suitable body part with one end being joined to another portion of the paper strip in a position to make the bracelet snug enough not to fall off. To remove the bracelet, the adhesive joint can be broken, which can in turn destroy the RFID tag, thereby destroying the RFID tag inoperative. In this manner, the RFID tag must be destroyed to remove the bracelet, thereby ensuring that even if a thief steals the electronic device and tears off the bracelet, the electronic device would be partially disabled, disabled, or otherwise inoperable.

Such paper or plastic strips having disposed thereon an RFID tag can be mass produced on rolls, such that a user can simply remove one each day, week, month, or other suitable time period, for wearing. The rolls can be formed from a strip of paper or plastic in which RFID tags are joined, such as by printing or adhesive, in predetermined intervals, including intervals of from about 2 inches to 24 inches, or from about 3 inches to about 18 inches, or from about 4 inches to about 12 inches, or from about 5 inches to about 10 inches, or any other range within any of the above ranges. Likewise, the strip can have perforations, or other lines of weakness to facilitate easy removal of one length which can include at least one RFID tag. In an embodiment, an RFID tag is disposed near, for example, within about 0.25 inches to about 5 inches, or from about 0.5 inches to about 3 inches, or from about 0.5 to about 1.5 inches from one of the lines of weakness.

Another way to ensure that an authorized user's remote coupled device could not be stolen and used with the authorized user's portable electronic device would be to have the remote coupled device also measure and detect at least one of the authorized user's biometrics. By biometrics is meant measurable parameters from a user's body, such as temperature, blood glucose level, and other biomarkers.

In one embodiment, the portable electronic device can be coupled to a remote coupled device that is an RFID sensor capable of measuring temperature. The RFID sensor can be in the form of a skin-proximity bracelet or necklace, or a patch, such as the GENTAG smart skin patch available from GENTAG. In one embodiment, the user can utilize the GENTAG GT-202 Smart Wireless Fever Monitoring Skin Patch. The GT-202 is compatible with Near Field Communication (NFC) cell phones, PC's and other electronic devices, can have a unique ID, can be adhesively attached and worn for one to two weeks, and can be programmed for temperature logging functions, measuring temperature with 0.1 C accuracy. When used with the present invention, temperature monitoring RFID tag, such as the GT-202 can be monitored by the portable electronic device. As long as the RFID tag is in close proximity to the authorized user's skin, the portable electronic device can measure at periodic intervals, such as intervals ranging from 0.1 seconds to 10 minutes and every one-tenth second interval in between. If the RFID tag experiences a temperature change, such as a decrease in temperature associated with being removed from the user's skin, the reported decrease in temperature (or other change) could initiate executable instructions in memory that cause the Smartphone to be disabled when the temperature change condition is detected.

Therefore, in one embodiment, the present invention can be described as a portable electronic device being dependently operable upon a remote coupled device, wherein the remote coupled device can be an RF addressable sensor, wherein the RF addressable sensor can be an RFID device capable of measuring and transmitting to the portable electronic device temperature, wherein operation of the portable electronic device for at least a portion of its intended use is dependent on being in proximity to the remote coupled device measuring a temperature within a predetermined temperature range.

Various additional embodiments for RF tags, RF addressable sensor networks, RF addressable sensors, and RF addressable sensor readers are described in the following subsections. These embodiments are provided for illustrative purposes, and it should be understood that the invention is not limited to the particular embodiments described below. Alternative embodiments for RF addressable sensor networks, RF addressable sensors, and RF addressable sensor readers will be apparent to persons skilled in the relevant arts based on the teachings herein, including those with equivalents, combinations, modifications, greater or fewer components, etc. It is to be understood that such alternative embodiments are within the scope and spirit of the present invention.

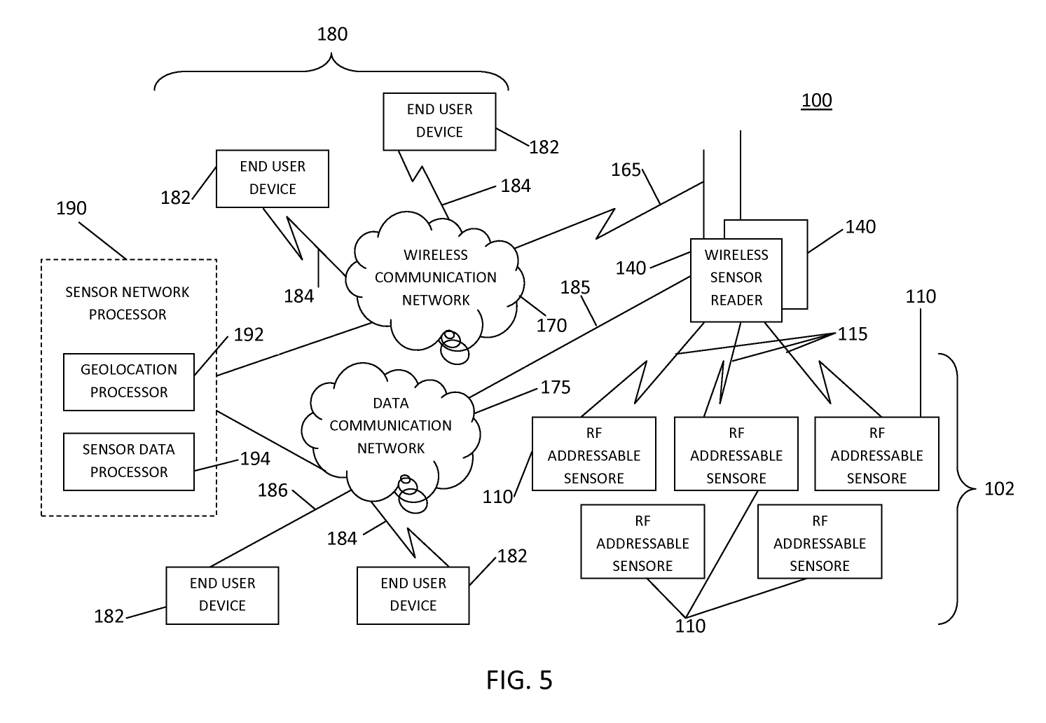

FIG. 5 is a block diagram of an illustrative RF addressable sensor network 100 for monitoring, detecting, and geolocating RF addressable sensors, according to an embodiment of the present invention. Network 100 includes a population of RF addressable sensors 102, one or more wireless addressable sensor readers (or, as above, interrogators) 140, and a communications network 180. In an embodiment of the present invention, communications network 180 is a publicly accessible communications network. In another embodiment, communications network 180 is a private network or a hybrid network including public and private portions. Communications network 180 includes a wireless communications network 170 and/or a data communications network 175. While FIG. 5 depicts communications network 180 as including a wireless and a data communications network, persons skilled in the relevant art(s) will recognize that other network architectures could be used with the present invention.

In an embodiment, end user devices (or, as above, portable electronic devices) 182 may be coupled to communications network 180. End user devices 182 can include logic for bi-directional communication with the communications network 180. End user devices 182 may be present to initiate a request for sensor data from RF addressable sensors 102 by making the request to readers 140 over network 180. In an embodiment, end user devices 182 also include logic to process received sensor data. For example, a user device 182 may include features of a processor 190, which is further described below. Thus, in an embodiment, a user device 182 may both initiate a request for sensor data and receive and process the resulting sensor data. End user devices 182 can communicate with communications network 180 via a wireless link 184 or a wired link 186. In an alternate embodiment, network 100 also includes a sensor network processor 190.

According to embodiments of the present invention, the population of RF addressable sensors 102 may include any number of one or more RF addressable sensors 110. RF addressable sensors 110 integrate RFID tag functionality and sensor functionality. RF addressable sensor 110 may be attached to the exterior of an item, inserted into an item (e.g., immersed in a liquid), may be adhered to a wearer's skin, or may be stand-alone.

Wireless sensor reader 140 includes logic to interrogate the population of RF addressable sensors 102 and logic to read sensor data and RFID tag data transmitted by the RF addressable sensors 110. In an embodiment, wireless sensor reader 140 also includes logic to process the received sensor data. Wireless sensor reader 140 can be any wireless device capable of communicating via an air interface protocol with the population of RF addressable sensors 102. In embodiments of the present invention, wireless sensor reader 140 could be a wireless phone, a personal digital assistant (PDA), a computer having wireless communications capabilities, or other type of mobile, handheld, and/or computing device.

According to the present invention, signals 115 are exchanged between the wireless sensor reader 140 and the population of RF addressable sensors 102 according to one or more protocols. Signals 115 are wireless signals, such as radio frequency (RF) transmissions. In an embodiment of the present invention, reader 140 and the population of sensors 102 communicate via a single protocol for both RFID tag communications and sensor communications. In an alternate embodiment, reader 140 and the population of sensors 102 communicate via a first protocol for RFID tag communications and via a second protocol for sensor communications. Examples of protocols used for RFID tag communications are described in the following co-pending U.S. patent applications, each of which is incorporated by reference in its entirety: application Ser. No. 10/072,984, filed Feb. 12, 2002, entitled “Radio Frequency Identification Architecture;” application Ser. No. 10/687,690, filed Oct. 20, 2003, entitled “Method for the Efficient Reading of a Population of Radio Frequency Identification Tags with Unique Identification Numbers Over a Noisy Air Channel;” and application Ser. No. 10/693,687, filed Oct. 27, 2003, entitled “Optimization of a Binary Tree Traversal with Secure Communications.” The present invention is also applicable to any other types of communication protocols between tags and readers otherwise known or yet to be developed.

In an embodiment of the present invention, signals 165 are exchanged between the wireless sensor reader 140 and the wireless communication network 170 according to one or more protocols. Signals 165 are typically RF signals. As can be appreciated by a person skilled in the relevant art(s), the communications protocol used between reader 140 and wireless network 170 can be any wireless air interface protocol, such as used in IS-41 or GSM wireless communications networks, for example.

In an alternate embodiment, wireless sensor reader 140 can also communicate to the data communications network 175 via interface 185. Interface 185 is a wired interface. For example, when wireless sensor reader 140 is a computer having wireless capabilities, sensor reader 140 may access the Internet via interface 185 using TCP/IP. As can be appreciated by a person skilled in the relevant art(s), the communications protocol used between reader 140 and data communications network 175 can be any data communications protocol.

In an embodiment of the present invention, wireless network 170 is a publicly accessible network, such as a switched telephone network supporting wireless communications. In an alternate embodiment, wireless network 170 may be a private network. Wireless network 170 may be coupled to a publicly accessible data communications network 175. Publicly accessible data communications network 175 can be a public switched telephone network or a public data network such as the Internet. In addition, data communications network 175 can be connected to other public or private networks as would be appreciated by persons skilled in the relevant art(s).

Sensor network processor 190 receives sensor data over network 180, and processes the data. Furthermore, in an embodiment, processor 190 transmits the processed data back over network 180 to reader 140, for example. Sensor network processor 190 includes a geolocation processor 192 and a sensor data processor 194. Sensor network processor 190 may be a stand-alone system or may be distributed across multiple systems. Geolocation processor 192 includes logic to receive data from one or more RF addressable sensors 110 and to perform GPS and/or non-GPS geolocation of the RF addressable sensors 110 based on the received data and/or signals. In GPS based geolocation, location is determined using signals provided to wireless sensor readers 140 via geo-stationary satellites. A limitation of GPS based geolocation is that signals are not available if the device is shielded (e.g., underground, in a building, etc.). In non-GPS based geolocation, location is determined by triangulation based on transmission systems as reference points (e.g., mobile base stations) and time to signal calculations. In this manner, cell phone towers can geolocate wireless sensor readers 140 through calculations done by processor 190. Similarly, wireless sensors readers 140 may be used as a basis to identify the precise location of individual sensors 110 by triangulation and synchronization of internal clocks. Since either the location of cell phone towers and/or wireless sensor readers is usually known and can include GPS coordinates, precise geolocation of sensors can be achieved using either GPS, non-GPS or hybrid systems.

For more information concerning geolocation, see U.S. Pat. No. 6,031,454, filed Nov. 13, 1997, entitled “Worker-Specific Exposure Monitor and Method for Surveillance of Workers,” which is incorporated herein by reference in its entirety.

Sensor data processor 194 includes logic to receive sensor data from one or more RF addressable sensors 110, perform processing on the received data, and communicate information based on the processing to wireless reader 140 or an end user device 182. Sensor network processor 190 is coupled to the wireless communications network 170 and/or the data communications network 175.

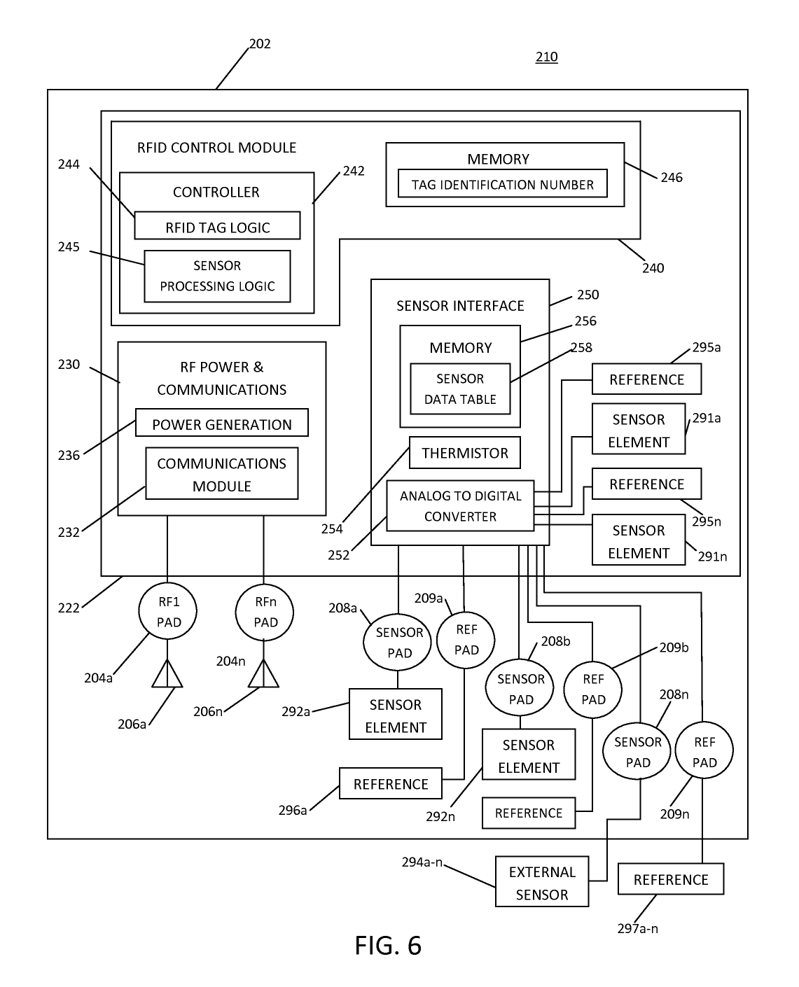

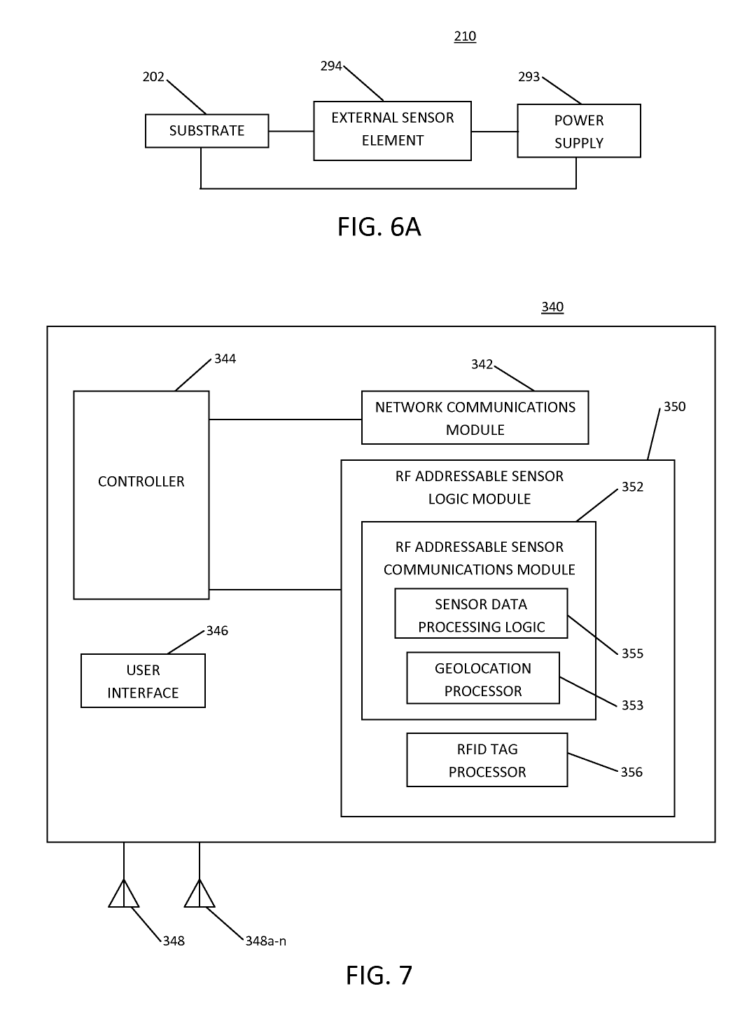

FIG. 6 is a block diagram of a radio frequency (RF) addressable sensor 210, according to an embodiment of the present invention. RF addressable sensor includes RFID tag functionality integrated with sensor functionality.

Radio frequency addressable sensor 210 includes an integrated circuit 222, a plurality of RF pads 204a through 204n, and a plurality of antennas 206a through 206n. These components are mounted or formed on a substrate 202. RF addressable sensor 210 also includes a plurality of sensor elements 291a-291n, 292a-292n, and 294a-294n.

Sensor elements may be included in integrated circuit 222, on substrate 202, external to substrate 202, or in any combination of the above. As shown in FIG. 2, sensor elements 291a-n are included as a component in integrated circuit 222. Sensor elements 292a-n are included on the substrate 202. Any sensor element that is compatible with the fabrication of RF addressable sensor 210 can be used. In an embodiment of the invention, sensor elements 292a-n can be thin film sensor elements that are deposited, printed, or directly assembled onto substrate 202. Sensor elements 294a-n are external to the substrate 202. If the sensor element is located on the substrate (collectively sensor elements 292) or external to the substrate (collectively sensor elements 294), the sensor element will be coupled to one or more of the plurality of sensor pads 208a through 208n (collectively sensor pads 208).

The structure of sensor pads 208 depends on the type of sensor element coupled to the sensor pad 208. In an embodiment of the present invention, sensor pads 208 are metal. However, certain biological sensor elements consist of soft materials. When coupling to metal sensor pads 208, the potential exists for these sensor elements to be pierced. In an alternate embodiment of the present invention, one or more sensor pads are soft sensor pads. These soft sensor pads provide a transition from a metal connection layer for coupling to the integrated circuit components to a soft connection layer for coupling to the sensor element. By using a soft transition method any type of external sensor element can be coupled to substrate 202. For example, doped inks or conductive polymers can be used to couple and bond substrate 202 to an integrated sensor as described below. The integrated sensor may be fabricated using other micro or nanofabrication techniques, thereby providing a means for an sophisticated integrated wireless sensor to be produced at a very low cost and for many different market applications.

Because of this flexible architecture, various types of sensor elements can be implemented in RF addressable sensor 210. An RF addressable sensor 210 may include only one type of sensor element or may include a combination of different types of sensor elements. Examples of sensor elements include: gas sensor elements that detect the presence of chemicals, such as those associated with drugs or precursor or trace chemicals of explosives such as Pentaerythritol Tetranitrate (PETN) and Hexahydro-1,3,5-triazine (RDX); temperature sensor elements that generate information indicating ambient temperature; accelerometers that generate information indicating movement or vibration; optical sensor elements that detect the presence (or absence) of light; pressure sensor elements that detect various types of mechanical pressures; tamper sensor elements that detect efforts to destroy or remove the sensor from affixed items; electromagnetic field sensor elements, radiation sensor elements; and biochemical sensor elements. However, this list is not exhaustive. RF addressable sensor 210 may include other types of sensor elements or combinations thereof, as would be apparent to persons skilled in the relevant art(s).

Sensor elements 291a to 291n are sensors that can be fabricated directly on the chip surface as part of integrated circuit 222. For example, these include sensors for temperature change, radiation, electrical changes, field effects and motion. Sensor elements 292a to 292n may be a number of different sensor types such as a chemical sensors, biological sensors, etc. In an embodiment, sensor element 292a may include of a plurality of special thin film elements such as polymers. For example, in chemical sensor elements, chemicals present in the air are absorbed differently by each of the thin film elements, changing the resistance of each and creating a characteristic electronic signature. Because many types of detectors can be added, this technology can be designed to recognize a wide range of chemicals. It should be noted that hybrid systems are also possible. For example, embedded passives may be used to create some of the electronic functionality on the chip and combined with sensor functionality.

In an alternate embodiment, one or more of the antennas 206 may be used as sensor elements. For example, the antenna could operate as an on-off sensor. As the antenna absorbs material to be sensed, the antenna becomes detuned and the tag stops operating. Thus, when the tag shuts off, the material has been sensed. In this embodiment, the antennas acting as sensor elements are coupled to both an RF pad 204 and a sensor pad 208. In an alternate embodiment, RF pads 204 are coupled to both the RF power and communications interface 240 and the sensor interface 250.

In an embodiment of the present invention, RF addressable sensor 210 is or includes a micro-electro-mechanical system (MEMS). In an embodiment, sensor elements can include mechanical and electromechanical devices “micromachined” on a common or separate substrate with the remaining components of the RF addressable sensor 210. In this embodiment, the remaining electronic components could be fabricated using conventional integrated circuit technology. For example, in a MEMS RF addressable sensor, one or more sensor elements can contain microcantilever devices.

In an alternate embodiment, the sensor elements 294a-294n are external to substrate 202 and can be fabricated using MEMS technology and attached to substrate 202, while the components included on substrate 202 can be fabricated using conventional technology. This allows any type of sensor to be coupled with an RFID tag.

FIG. 6A is a block diagram of an RF addressable sensor 210 having an external sensor element according to embodiments of the present invention. External sensor element 294 may be coupled to an independent power supply 293. Substrate 202 may also or alternatively be coupled to independent power supply 293. In an embodiment, power supply 293 is a disposable battery or a photovoltaic cell. Thus, sensor element 294 does not require periodic “power” signals from the wireless reader. In an embodiment, sensor element 294 includes a memory.

An advantage of the RF addressable sensor configuration of FIG. 2A is that the wireless components and geolocation features can be provided by the RFID tag and cell phone combination thereby reducing the cost and making it suitable for sensor networks. An example of an application is a homeland security network with sensors that are dispersed by airplane over certain areas together with low cost readers. If a hazard is detected, sufficient power is present at the sensor level to send a “wake up” signal to a nearby reader. The reader then geolocates itself and the sensor and relays the information to a remote processor 190. Cross validation of sensor events may then be achieved by activating and reading other sensors in the same geographical area. A further advantage is that the present invention can be used in combination with sensors that require more power than is available on an RFID tag. In addition, sensor elements that require very different manufacturing processes than the RFID tag can also be used in the present invention.

In an embodiment of the present invention, as shown in FIG. 6, RF addressable sensor 210 optionally includes a plurality of reference elements 295a-295n, 296a-296n, and 297a-297n. Similar to the sensor elements, reference elements may be included in integrated circuit 222, on substrate 202, external to substrate 202, or in any combination of the above. As shown in FIG. 2, reference elements 295a-295n are included in integrated circuit 222; reference elements 296a-296n are included on substrate 202; and reference elements 297a-297n are external to substrate 202. A sensor element need not have a reference element. If the reference element is located on the substrate (collectively reference elements 296) or external to the substrate (collectively reference elements 297), the reference element will be coupled to one or more of the plurality of reference pads 209a through 209n (collectively reference pads 209).

Reference elements allow for the cross validation of sensor data and establish baselines. This is important for chemical measurements, for biological sensors, and for any sensor situation where there are two or more variables and at least one of the variables is dependent or proportional to the other.

In an embodiment of the present invention, a sensor element may have a plurality of associated reference elements. In an embodiment, a reference element provides a baseline and/or calibrated value to which a sensor element can be compared either internally or externally. In an embodiment, reference data can be transmitted by the RF addressable sensor to the wireless sensor reader or to the network sensor processor for calibration of the sensor elements.

As shown in the embodiment of FIG. 6, integrated circuit 222 includes a RF power and communications interface 230, a sensor interface 250, and an RFID control module 240. Sensor interface 250 includes a digitizer or an analog to digital converter (ADC) 252. ADC 252 receives analog signals from sensor elements and converts the analog signal into a corresponding digital signal. ADC 252 can be coupled directly to sensor elements implemented in integrated circuit 222 and is coupled to other sensor elements 292 and 294 via sensor pads 208. In an embodiment, a filter (not shown) may be used between the sensor element and ADC 252.

In an embodiment of the present invention, sensor interface 250 optionally includes one or more thermistors 254. Thermistor 254 is a device that has an electrical resistance that varies predictably with temperature. Thermistor 254 provides a correlation point for data obtained from a sensor element. Because temperature is a generally known variable, including a thermistor in RF addressable sensor 210 allows the sensor 210 to use temperature as a basis for comparison or allows a sensor element output value to be adjusted based on temperature. This adjustment can occur internally or externally at the wireless sensor reader 140, end user device 182, and/or network sensor processor 190.

In an embodiment of the present invention, thermistor 254 is made of a material such as a metal-oxide that has a resistance that changes in a linear fashion according to temperature. Hence, at a given temperature, the thermistor has a certain value that can be correlated precisely to a given temperature. The calibration of thermistor 254 can be done in batches after the chip is microfabricated. Calibration can be achieved by bringing the chip to a set temperature and programming into the chip the corresponding value. This process can be repeated at two different temperatures, thereby providing the reference in memory.

In an embodiment of the present invention, thermistor 254 is made of a non-linearly changing material. In this embodiment, additional calibration points are used. As would be appreciated by persons skilled in the relevant art(s), other implementations of thermistor 254 can be used in the present invention.

In an embodiment, sensor interface 250 may optionally include a memory 256. Memory 256 stores information used by RF addressable sensor 210 to process sensor data received from sensor elements. The information may be stored permanently or temporarily. In an embodiment of the present invention, memory 256 is a programmable memory. The stored information may be used internally by the RF addressable sensor 110 or may be communicated for use externally by the wireless sensor reader 140, an end user device 182, and/or the network sensor processor 190.

In an embodiment, memory 256 stores a sensor data table 258. The sensor data table 258 is configured to store data related to all or a subset of sensor elements supported by the RF addressable sensor 210. For example, the sensor data table may store a sensor element identification number, a preferred read time, spacing interval between reads, and/or sensor element specific data for all or a subset of sensor elements.

Using this approach a universal sensor platform is created based on RFID technology by allowing wireless devices such as phones to become “smart” sensor reader devices. In an embodiment, a wireless device such as a phone is modified to include RFID-sensor tag reader functionality, as described herein. In an embodiment, when a sensor 110 having data table 258 is activated by wireless sensor reader 140, the sensor 110 identifies itself (e.g., by providing its identification number) and can provide the cell phone reader with the necessary information for analyzing the sensor output. In an embodiment, sensor data table 258 also includes sensor handling information that is communicated to reader 140. For example, if sensor 110 is to detect a specific allergen in food, a complete step-by-step testing protocol can be provided and can be displayed directly on the screen of the phone or reader device 140. In another embodiment, some or all of the necessary information to handle and analyze the sensor is retrieved from processor 190.

Software may also be downloaded directly and transparently into the cell phone or reader 140 to “train” the wireless device to recognize and analyze that given type of RFID-sensor. This information may be stored permanently or temporarily in wireless device 140. When the necessary processing and analysis information is downloaded from a remote location, only the ID of the RFID-sensor is necessary, providing a highly streamlined solution for universal sensor analyses for wireless devices such as cell phones. In another embodiment, hybrid systems can be provided whereby only a basic sensor analysis protocol can be downloaded into the cell phones and the sensor data processing is done remotely. This situation is particularly applicable where complex multivariate analyses of sensor data are required. Phones may also include in permanent memory a summary table with the necessary IDs to recognize any type of sensor. The above described method allows an ordinary wireless device to instantly become a “smart” device for any type of sensor

Integrated circuit 222 can accommodate multiple antennas 206a through 206n. This allows RF addressable sensor 210 to have a variety of antenna configurations on substrate 202. For example, wireless sensor reader 140 (shown in FIG. 1) may operate at a different frequency or have different directivity than conventional RFID readers. Therefore, RF addressable sensor 210 may have one or more antennas configured to communicate with a conventional RFID reader and one or more antennas configured to communicate with wireless sensor reader 140.

The RFID control module 240 controls RF communications between the RF addressable sensor 210 and wireless sensor reader 140. RFID control module includes a controller 242 and a memory 246. Controller 242 includes RFID tag logic 244 to respond to RFID tag interrogation and read communications by the wireless sensor reader 140 or another tag reader and logic to control the operating state of the RFID tag components of the RF addressable sensor. For more information concerning interrogation of tags, and more generally, communication between an RFID reader and a population of tags in accordance with an embodiment of the present invention, see U.S. Pat. No. 6,002,344, entitled, “System and Method for Electronic Inventory” which is incorporated herein by reference in its entirety, and the following co-pending U.S. patent applications, each of which is incorporated by reference in its entirety: application Ser. No. 09/323,206, filed Jun. 1, 1999, entitled “System and Method for Electronic Inventory”; application Ser. No. 10/072,855, filed Feb. 12, 2002, entitled “Method, System and Apparatus for Binary Traversal of a Tag Population” (Publication No. 0149481-A1); and application Ser. No. 10/073,000, filed Feb. 12, 2002, entitled “Method, System and Apparatus for Communicating with a RFID Tag Population.”

Controller 242 may optionally include sensor processing logic 245 to process sensor data obtained by sensor elements. Memory 246 stores information used by the RF addressable sensor when operating as a RFID tag. Memory 246 may be separate or integrated with memory 256 of the sensor interface. The information may be stored permanently or temporarily. Memory 246 stores the tag identification number for the RF addressable sensor 210. In an embodiment of the present invention, the tag identification number indicates the type of sensor elements included in the RF addressable sensor 210.

RF Power and Communications Interface 230 includes a communications module 232 and a power generation module 236. Communications module 232 is coupled to antennas 206 to provide bi-direction communication with a wireless RF addressable sensor reader. In an alternate embodiment, communication module 232 provides bi-directional communication with a conventional RFID reader in addition to the wireless RF addressable sensor reader. In an embodiment, power generation module 236 provides integrated circuit 222 with an operational voltage based on the RF energy transmitted by wireless sensor reader 140 and received by the corresponding RF addressable sensor 110. In another embodiment, power generation module 236 may also include a battery or other power source. Alternatively, power generation module 236 may only include a battery or other power source. When present, the power source provides the operational voltage for integrated circuit 222. In addition, the power generation module 236 may provide operational voltage for sensor elements 292a-n and/or 294a-n. For example information concerning power generation in an RFID tag, see U.S. patent application Ser. No. 10/383,537, filed Mar. 10, 2003, entitled, “Efficient Charge Pump Apparatus” which is incorporated herein by reference in its entirety.

In an embodiment, when a power source is present, the RF addressable tag may include logic to activate the reader when certain conditions are sensed, on the occurrence of a pre-defined event, and/or at pre-defined intervals. As would be appreciated by persons skilled in the art, many RFID tag communications protocols can be used to activate the reader according to the present invention.

Example embodiments for wireless sensor reader 140 are described in this section. FIG. 7 is a block diagram of a wireless sensor reader 340 according to example embodiments of the present invention. Wireless sensor reader 340 includes a network communications module 342, a controller 344, a user interface 346, and an RF addressable sensor logic module 350. Wireless sensor reader 340 also includes one or more antennas. Antenna 348 is configured for communication with wireless network 170. Antenna 348 is included when wireless reader 340 is integrated with a wireless communications device. In an embodiment of the present invention, antenna 348 is also configured for communication with the population of RF addressable sensors. Antennas 349a-n are included when antenna 348 does not support communication with the population of RF addressable sensors. In this embodiment, antennas 349 are configured to communicate with the RF addressable sensors 110. In an alternate embodiment, network antenna 348 can be removed (e.g., unscrewed) from reader 340 and replaced with an RFID antenna 349 for communication with the population of sensors 102. Controller 344 includes logic to coordinate and control the operation of the components of wireless sensor reader 340. In an embodiment, controller 344 coordinates substantially continuous RF communication with sensors 110. Substantially continuous RF communication can be by periodic send and receive sequences at predetermined intervals which can be from a range of once every millisecond to once every half hour, the range including every millisecond interval in between. Thus, one second, one minute, two minutes, ten minutes, and every other multiple of milliseconds between one and half an hour, are literally disclosed herein.

User interface 346 can provide a mechanism for the user of the wireless sensor reader 340 to access and interact with sensor information and/or initiate a read of one or more sensors 110. User interface 346 may include a display and/or keypad for entering data (e.g., the numerical keypad of a wireless phone). In an alternate embodiment, user interface 346 includes a standalone button for initiating sensor reads and/or processing. In addition, the wireless sensor reader 340 includes a display for displaying data obtained from RF addressable sensors 110. In an embodiment, the wireless sensor reader 340 also includes an alarm for indicating when certain thresholds are reached or certain conditions are detected by an RF addressable sensor.

A user may alternatively initiate sensor processing by entering a pre-defined sequence of characters via a key pad (e.g., by entering *2222). Alternately, a user could initiate sensor processing by highlighting or activating an option provided through a display or by a predefined voice command.

Network communications module 342 includes one or more transmitters and receivers for communicating with the data communications network 175 and/or wireless communications network 170. In an embodiment of the present invention, wireless sensor reader 340 communicates with wireless network 170 via network antenna 348. Accordingly, network communications module 342 includes a wireless interface coupled to the antenna 348. In an alternate embodiment of the present invention, wireless sensor reader 340 communicates with a publicly accessible data communications network 175 via a wired connection. In this embodiment, network communications module 342 includes a wired network interface. If both types of communications are supported, network communications module 342 will include both a wireless interface and a wired interface.

RF addressable sensor logic module 350 includes an RF addressable sensor communications module 352 and an RFID tag processor 356. Wireless sensor reader 340 communicates with the population of RF addressable sensors 102 via either the network antenna 348 or via one or more RFID antenna(s) 349a-349n. If wireless sensor reader 340 communicates with the population of RF addressable sensors via one or more RFID antenna(s) 349a-n, RF communications module 352 will include one or more transmitters and receivers coupled to antennas 349. As will be appreciated by a person skilled in the relevant art(s), RF communications module 352 may be implemented in hardware, software, firmware, or in combination thereof.

RFID tag processor 356 includes logic to interrogate and read RFID tag information from RF addressable sensors 110. As will be appreciated by a person skilled in the relevant art(s), RFID tag processor 356 may be implemented in hardware, software, firmware, or in combination thereof.

RF addressable sensor communications module 352 can include sensor data processing logic 355 and geolocation processing logic 353. Sensor data processing logic 355 can be configured to request a read of one or more addressable sensors 110 based on input from a user, after a certain interval of time, and/or upon the occurrence of a pre-defined event. Sensor data processing logic 355 is also configured to process received sensor data.

Geolocation processor 353 is optional, and when present, includes algorithms to perform GPS based geolocation and/or non-GPS based geolocation. In an embodiment, sensor reader 340 serves as a geolocation beacon for RFID-sensors in synchrony with other readers. In an embodiment, the antenna serves as a means for directional geolocation of RFID sensors.

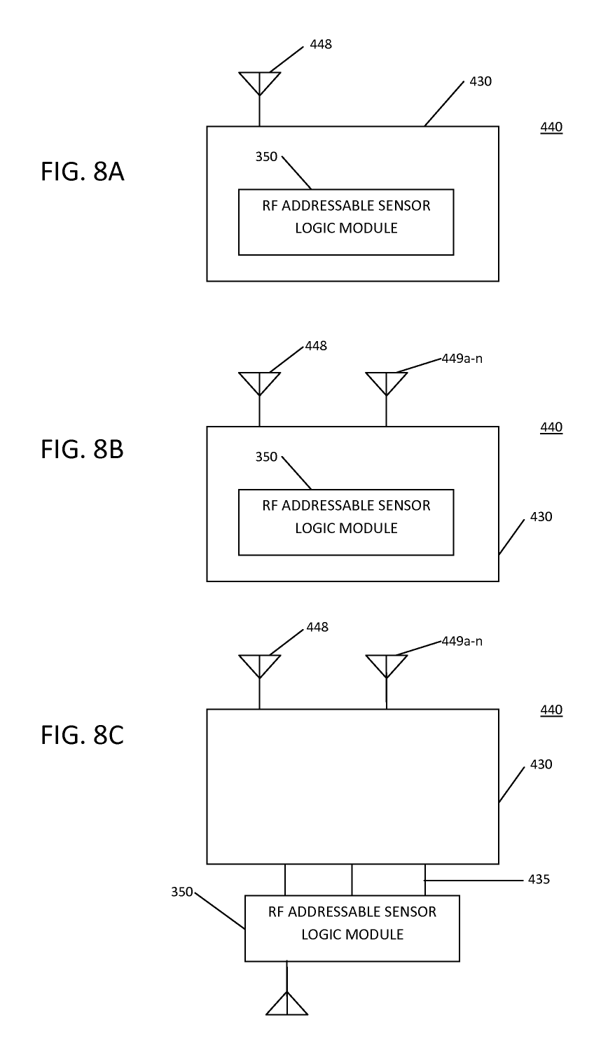

FIGS. 8A-C depict block diagrams of example configurations for a wireless sensor reader 440. Each configuration depicts various ways in which RF addressable sensor logic module 350 and RFID antennas 349a-n may be incorporated into a device 430. Device 430 can be an existing wireless device such as a computer, tablet computer, Smartphone, wireless phone or PDA. In an alternate embodiment, device 430 is a device designed specifically to support communicating with RF addressable sensors 110 and with a communications network such as a wireless phone network or the Internet.

In FIG. 8A, RF addressable sensor logic module 350 is integrated into device 430. In this embodiment, wireless sensor reader 440 communicates with both the wireless network 170 and the population of RF addressable sensor tags via antenna 448. In an embodiment of the present invention, module 350 is built into device 430. In an alternate embodiment, device 430 includes a programmable processor. The logic for module 350 can be downloaded and stored in the programmable processor. The logic can be downloaded via the air interface, an infrared port, a data connection through the accessory port, or via any other interface or link capable of transferring data to device 430.

In FIG. 8B, RF addressable sensor logic module 350 is integrated into device 430, as discussed in reference to FIG. 8A. However, in this embodiment, one or more antennas 449a-n are already included, or added onto device 430 for communication with the population of RF addressable sensors 102. Note that for this configuration, antenna 448 is optional and is not included if wireless sensor reader 340 only communicates with a data communications 175 network via a wired connection.

In FIG. 8C, RF addressable sensor logic module 350 is external to device 430 and is attached to device 430 via interface 435. For example, interface 435 could be an accessory port, an infrared port, or any other interface or port capable of transferring data to and from device 430 such as a wireless phone data/software interface. For example, module 350 may be a snap-on and/or plug-in module to device 430. Various antenna configurations are supported with this embodiment. In an embodiment, existing antenna 448 supports communication with both the network 170 and the population of sensors 102. In an alternate embodiment, additional antennas 449 for communicating with the population of sensors 102 are attached to external module 350. In another alternate embodiment, additional antennas 449 for communicating with the population of sensors 102 are attached to device 430. As would be appreciated by a person skilled in the relevant art(s), other configurations for wireless sensor reader 440 are possible.

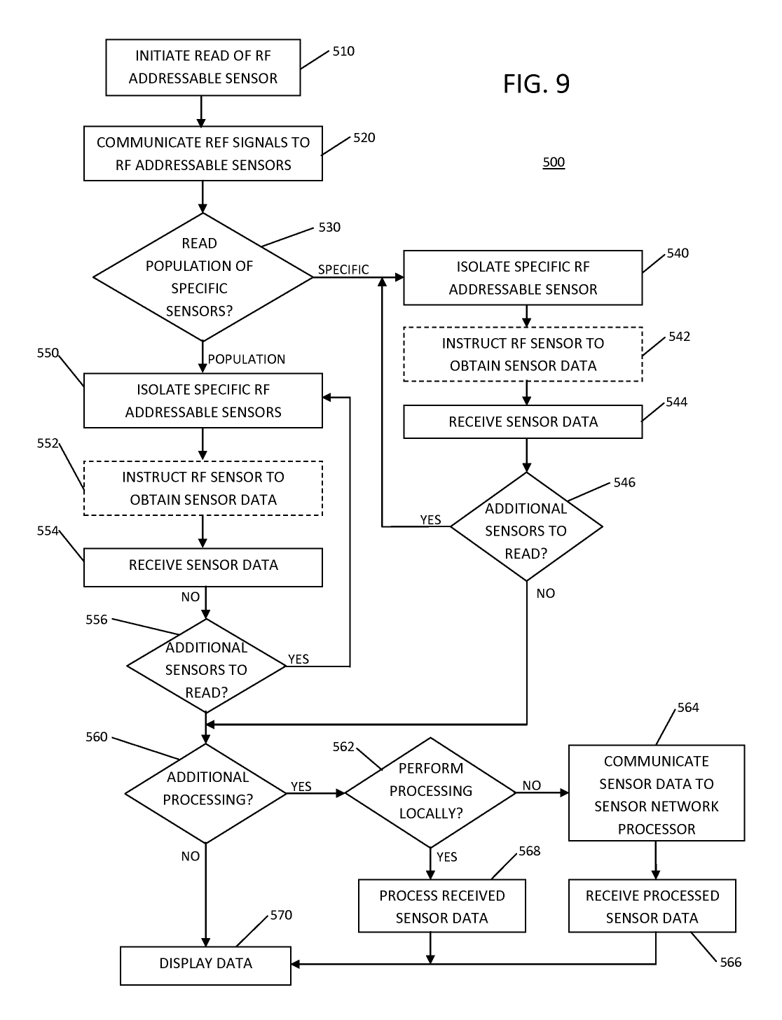

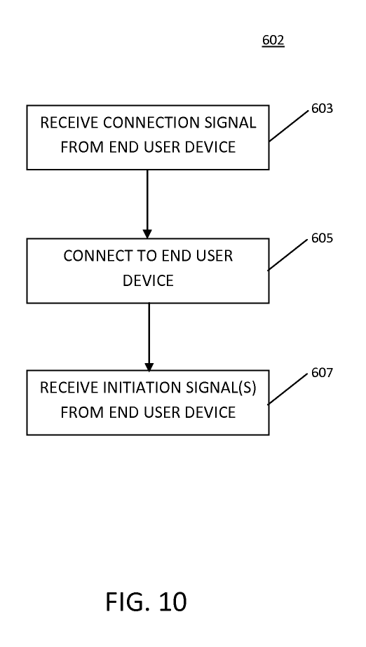

FIG. 9 is a flowchart of a method 500 for RF addressable sensor read communications from the perspective of a wireless sensor reader. Method 500 will be described with continued reference to FIGS. 5 and 7. Note that some steps shown in the flowchart do not necessarily have to occur in the order shown.

Method 500 begins with step 510. In step 510, a read of one or more RF addressable sensors is initiated. In an embodiment of the present invention, sensor data processing logic 355 includes logic that periodically initiates sensor read communications. For example, sensor data processing logic 355 may automatically initiate a sensor read every second, every minute, or every 15 minutes. A sensor read may also be initiated manually via the user interface 346 of wireless sensor reader 140/340. For example, a user may initiate a read by activating a display icon or option. In an embodiment, a user may initiate a read by pressing a series of keys on the device keypad (e.g., *2222) or by pressing a specifically configured sensor read button. Alternatively, if the device supports voice activated commands, the user may initiate a sensor read by speaking the appropriate command.

In addition, a sensor read can be initiated remotely over data communications network 175 or the wireless network 170. FIG. 10 depicts a method 602 for remotely initiating a sensor read according to embodiments of the present invention. Method 602 begins with step 603. In step 603, the wireless sensor reader 140/340 receives a connection signal from an end user device 182. As would be appreciated by a person skilled in the relevant art(s), the type and format of the connection signal depends upon the implementation of the end user device 182 and the wireless sensor reader 140/340. For example, if the wireless sensor reader 140/340 is also a wireless telephone device, the connection signal may be a telephone call by the end user device to the wireless sensor reader. Alternatively, end user device may be a data terminal. In this example, the connection signal may be any type of data communications connection signals.

In step 605, the wireless reader 140/340 connects to the end user device over a communications network.

In step 607, the wireless reader 140/340 receives initiation signal(s) from the end user device. As would be appreciated by a person skilled in the relevant art(s), the type and format of the initiation signal(s) depends upon the type and format of the connection signal. If a telephone connection is established, then the initiation signals may be a series of dual tone multifrequency (DTMF) signals or a voice command. Control then proceeds to step 520.

Returning to FIG. 9, in step 520, the wireless sensor reader 140/340 communicates RF signals to one or more addressable sensors 520. These RF signals can serve a dual purpose. They can initialize the RF addressable sensors for communications and provide operating power to the sensors.

Based on the details provided during read initiation, the wireless sensor reader 140/340 may perform a sensor read of the entire population of RF addressable sensors 102 or may perform a read of a specific set of RF addressable sensors. In step 530, the reader determines whether to read the entire RF addressable sensor population 102 or one or more specific RF addressable sensors 110. If the entire population is to be read, operation proceeds to step 550. If one or more specific sensors 110 are to be read, operation proceeds to step 540.

For example, a user may obtain (e.g., purchase) a batch of RF addressable sensors. The user may store the tag identification numbers associated with each RF addressable sensor in the wireless sensor reader prior to initiating a read of the sensors. The reader can then isolate only those specific RF addressable sensors stored in the wireless sensor reader.

In step 540, RFID tag processor 356 isolates (e.g., singulates) the specific RF addressable sensor 110 to be read. Processor 356 may isolate a sensor 110 through an interrogation protocol, or other mechanism. For details on methods for isolating a specific tag, see pending U.S. Application entitled, “Radio Frequency Identification Architecture,” referenced above. As would be appreciated by persons skilled in the relevant art(s), other protocols and methods for reading and isolating tags can be used with the present invention.

In step 542, the wireless sensor reader 140/340 can, in addition to merely recognizing the presence of an RF tag or RF addressable sensor, instruct the specific RF addressable sensor 110 to obtain sensor data. This can be done via a predefined command. In an alternate embodiment, RF addressable sensor 110 automatically signals sensor data to wireless sensor reader 140/340 upon being isolated. In this embodiment, step 542 is optional.

In step 544, the wireless sensor reader 140/340 receives the sensor data from the RF addressable sensor 110. Sensor data can include data confirming the proximity (i.e., the presence of) a sensor, sensor element output data, sensor table data, reference data, and/or other data.

In step 546, the wireless sensor reader 140/340 determines whether any additional specific RF addressable sensors are to be read. If no additional sensors are to be read, operation proceeds to step 560. If additional sensors remain to be read, operation proceeds to step 540.

In step 550, the RFID tag processor 356 isolates an RF addressable sensor 110 from the population 102 using a conventional general read protocol such as binary tree traversal.

In step 552, the wireless sensor reader 140/340 instructs the identified RF addressable sensor 110 to obtain sensor data. This can be done via a predefined command. In an alternate embodiment, RF addressable sensor 110 automatically signals sensor data to wireless sensor reader 140/340. In this embodiment, step 552 is optional.

In step 554, the wireless sensor reader 140/340 receives the sensor data from the RF addressable sensor 110.

In step 556, the wireless sensor reader 140/340 determines whether any additional RF addressable sensors remain to be read. If no additional sensors remain to be read, operation proceeds to step 560. If additional sensors remain to be read, operation proceeds to step 550.

In step 560, the wireless sensor reader 140/340 determines whether any additional processing must be done on the received sensor data. If additional processing must be performed, operation proceeds to step 562. If no additional processing must be performed, operation proceeds to step 570.

In step 562, the wireless sensor reader 140/340 determines whether the additional processing is to be performed locally or remotely. If processing can be performed locally, operation proceeds to step 568. If processing is to be performed remotely, operation proceeds to step 564. For example, some types of processing may be too resource intensive to perform efficiently on the wireless sensor reader 140/340 or may require data not available to the wireless sensor reader 140/340. In this situation, remote sensor processing is selected for the sensor data.

In step 564, the wireless sensor reader 140/340 can optionally communicate the received sensor data to sensor network processor 190 over communications network 180. In an embodiment, the wireless sensor reader may also communicate additional data to the sensor network processor 190 such as data needed to perform geolocation. Upon receipt, sensor network processor 190 may perform additional processing on the data and/or perform geolocation to determine the location of the RF addressable sensor 110 that generated the sensor data.

In step 566, wireless sensor reader 140/340 receives the processed sensor data from sensor network processor 190.

In step 568, sensor data processing logic 355 processes the received sensor data. If sensor data is not received, or data received is not the sufficient for continued user authentication, the wireless sensor reader can be partially or completely disabled.

In step 570, the received sensor data or processed sensor data can optionally be displayed. In an embodiment of the present invention, the data can be displayed via a user interface 346 on wireless sensor device 140/340. In an alternate embodiment, the data may also be communicated to one or more end user devices over communications network for display. Step 570 is optional.

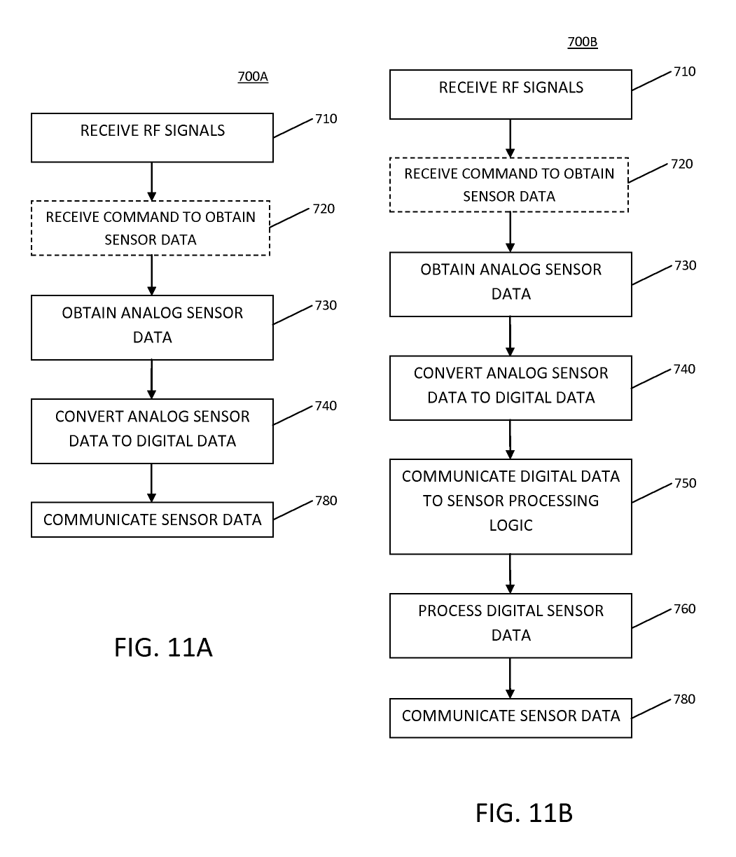

FIG. 11A is a flowchart of a method 700A for basic RF addressable sensor read communications from the perspective of single RF addressable sensor 110 according to an embodiment of the present invention. Method 700A will be described with continued reference to FIGS. 5 and 6. Note that some steps shown in the flowchart do not necessarily have to occur in the order shown.

Method 700A begins with step 710. In step 710, RF addressable sensor 110 receives RF signals from wireless sensor reader 340. In an embodiment, step 710 includes the step where the received RF signal is used to power sensor 110. Furthermore, step 710 may include the step where sensor 110 identifies itself to reader 340.

In step 720, sensor 110 receives a command from reader 340 to send back a confirming signal, or to obtain sensor data. Step 720 can be optional. In an embodiment of the present invention, RF addressable sensor 110 obtains sensor data automatically each time a communication session with a reader 340 is initiated.

In step 730, analog sensor data is obtained by one or more sensor elements 291, 292 and/or 294 and communicated to ADC 252.

In step 740, ADC converts the analog sensor data into digital sensor data.

In step 780, the RF addressable sensor 110 communicates the digital sensor data to wireless sensor reader 140/340. The details of this communication are dependent upon the protocol used for communication between the wireless sensor reader 140/340 and the RF addressable sensor 110. In an embodiment of the present invention, the protocol used is a binary tree traversal protocol. In this embodiment, the tag identification number signaled by the RF addressable sensor 110 may include both the tag identification number stored in memory 246 and the sensor data obtained by the sensor elements. Alternatively, reader 140/340 may place the RFID tag logic 244 in a command state. In the command state, the RFID tag logic responds to commands received from the reader. When the RFID tag logic 244 receives an obtain sensor data command signal, the RFID tag logic will signal the sensor data to the reader 140/340. In an embodiment, the sensor data communicated to reader 140/340 may include temperature data, sensor data, reference data and/or data stored in sensor data table 258.

FIG. 11B is a flowchart illustrating a method 700B of RF addressable sensor read communications from the perspective of an RF addressable sensor having local processing capabilities, according to an embodiment of the present invention. Method 700B will be described with continued reference to FIGS. 5 and 6. Note that some steps shown in the flowchart do not necessarily have to occur in the order shown.

Steps 710 through 740 are generally the same as steps 710 through 740 discussed above in reference to FIG. 11A.

In step 750, the converted digital sensor data is communicated to sensor processing logic 245.

In step 760, the sensor processing logic 245 processes the converted sensor data.

Step 780 is generally the same as step 780 discussed above in reference to FIG. 11A.

In each embodiment herein, upon non-receipt of a return signal, or non-receipt of a predetermined return signal and/or data from an RF tag, RF addressable sensor, or other remote coupled device, the portable electronic device or wireless sensor reader can be partially or completely disabled.

All of the US patents and patent applications disclosed herein are incorporated herein by reference.

1. A portable electronic device, said portable electronic device being dependently operable on being remotely coupled to at least one RFID tag, said RFID tag being disposed on one of a piece of jewelry or a portion of clothing worn on a person, such that upon removal of said jewelry or clothing said RFID tag is rendered inoperable and said electronic device is partially or completely disabled.

2. The device of claim 1, wherein said electronic device is selected from the group consisting of cellular telephone, Smartphone, tablet computer, net book computer, laptop computer, GPS system, virtual wallet, virtual car key, and virtual house key.

3. The device of claim 1, wherein said electronic device is enabled for full operation when in communication with said RFID tag, but is at least partially disabled when not in communication with said RFID tag.

4. The electronic device of claim 4, wherein said RFID tag measures at least one parameter from a user's biometrics.

5. The electronic device of claim 1, wherein said RFID tag is disposed on a paper or plastic bracelet.

6. (canceled)

7. (canceled)

8. (canceled)

9. (canceled)

10. (canceled)

11. (canceled)

12. The electronic device of claim 5, wherein said RFID tag is destroyed upon removal of said bracelet.

13. A portable electronic device, said portable electronic device being dependently operable on being remotely coupled to at least one RFID addressable sensor, said RFID addressable sensor being disposed on a piece of jewelry or a portion of clothing worn on a person.

14. The device of claim 13, wherein said electronic device is selected from the group consisting of cellular telephone, Smartphone, tablet computer, net book computer, laptop computer, GPS system, virtual wallet, virtual car key, and virtual house key.

15. The device of claim 13, wherein said electronic device is enabled for full operation when in communication with said RFID addressable sensor, but at least partially disabled when not in communication with said RFID addressable sensor.

16. The electronic device of claim 13, wherein said RFID addressable sensor is disposed on a bracelet.

17. The electronic device of claim 16, wherein said RFID tag is destroyed upon removal of said bracelet.

18. A portable electronic device, said portable electronic device being dependently operable on being remotely coupled to at least one RFID addressable sensor, said RFID addressable sensor being programmable by said portable electronic device.

19. The device of claim 18, wherein said electronic device is selected from the group consisting of cellular telephone, Smartphone, tablet computer, net book computer, laptop computer, GPS system, virtual wallet, virtual car key, and virtual house key.

20. The device of claim 18, wherein said electronic device is enabled for full operation when in communication with said RFID addressable sensor, but at least partially disabled when not in communication with said RFID addressable sensor.

21. The electronic device of claim 18, wherein said RFID addressable sensor is disposed in close proximity to a user's body.

22. The electronic device of claim 18, wherein said RFID addressable sensor is disposed on a bracelet.

23. The electronic device of claim 22, wherein said RFID tag is destroyed upon removal of said bracelet.
